(19) United States
(12) Patent Application Publication
(10) Pub. No.: US 2026/0172105 A1
(43) Pub. Date: Jun. 18, 2026

(54) COMMUNICATION METHOD AND APPARATUS OF AN AERIAL RELAY IN WIRELESS COMMUNICATION SYSTEM

(71) Applicant: Electronics and Telecommunications Research Institute, Daejeon (KR)

(72) Inventors: Minkyeong JEONG, Seoul (KR); Jieun YU, Seoul (KR); Kyuyeon LEE, Seoul (KR); Kwangmyeong YANG, Seoul (KR); Chungyong LEE, Seoul (KR); Dukhyun YOU, Daejeon (KR); Hoondong NOH, Daejeon (KR)

(21) Appl. No.: 19/362,273

(22) Filed: Oct. 17, 2025

(30) Foreign Application Priority Data
Oct. 17, 2024 (KR) 10-2024-0141939
Oct. 15, 2025 (KR) 10-2025-0148775

(51) Int. Cl. H04B 7/185; H04W 64/00

(52) U.S. Cl. CPC H04B 7/18506; H04W 64/003

(57) ABSTRACT

A method of an aerial relay may comprise: estimating, at first time intervals for a predetermined number of times, a position of the aerial relay based on a pilot signal received from a base station; measuring a quality of the received pilot signal whenever the position of the aerial relay is estimated; and transmitting, at the first time intervals for the predetermined number of times, a report message including the estimated position of the aerial relay and the quality of the received pilot signal to the base station.

### CROSS-REFERENCE TO RELATED APPLICATIONS

This application claims priority to Korean Patent Applications No. 10-2024-0141939, filed on Oct. 17, 2024, and No. 10-2025-0148775, filed on Oct. 15, 2025, with the Korean Intellectual Property Office (KIPO), the entire contents of which are hereby incorporated by reference.

### BACKGROUND

### 1. Technical Field

The present disclosure relates to a communication technique in a wireless communication system, and more particularly, to a communication technique for an aerial relay.

### 2. Related Art

In current wireless communication systems, communication methods that rely solely on terrestrial networks (TN) have generally been predominant. A TN may refer to a network in which, for example, both a base station and a terminal are located on the ground, and may also refer to a network in which a relay node used for a connection between a base station and a terminal or between base stations is located on the ground. However, when a communication system is constructed using only TNs in areas with many obstacles, such as urban areas or mountainous regions, stable communication service cannot be provided due to geographical limitations and/or coverage issues of the networks.

To address such problems, research has recently been actively conducted on methods for connecting a base station and a terminal and/or for connecting base stations by using an airborne platform as a relay node (hereinafter referred to as ‘aerial relay’). Since the aerial relay moves in the air, its movement may be relatively unrestricted. Accordingly, by appropriately placing aerial relays in environments where stable communication service is difficult to provide between base stations and terminals, the network may not only expand its coverage but also provide stable communication service to users.

However, further research is required on efficient resource management and appropriate communication methods using aerial relays. In particular, research is needed on efficient resource management considering time-varying channel environments, user tracking, and optimal placement methods in real time in accordance with network environments.

### SUMMARY

The present disclosure for resolving the above-described problems is directed to providing efficient resource management and communication methods using an aerial relay.

A method of an aerial relay, according to an exemplary embodiment of the present disclosure, may comprise: estimating, at first time intervals for a predetermined number of times, a position of the aerial relay based on a pilot signal received from a base station; measuring a quality of the received pilot signal whenever the position of the aerial relay is estimated; transmitting, at the first time intervals for the predetermined number of times, a report message including the estimated position of the aerial relay and the quality of the received pilot signal to the base station; moving to a first position based on receiving, from the base station, a first message including instruction information for instructing the aerial relay to operate as a relay node and information on the first position in response to the report message; and transmitting a movement report message to the base station based on the aerial relay being moved to the first position, wherein the aerial relay moves by a predetermined distance at the first time intervals.

The predetermined number may be a value preset by the base station through a first link established between the base station and the aerial relay, and the first link may be different from a second link through which the aerial relay relays a signal transmitted from the base station to a terminal while the aerial relay operates as the relay node.

A resource in which the report message is transmitted may be preconfigured through a first link established between the base station and the aerial relay, and the first link may be different from a second link through which the aerial relay relays a signal transmitted from the base station to a terminal while the aerial relay operates as the relay node.

The position of the aerial relay may be estimated using an angle of arrival (AoA) of the pilot signal received from the base station.

The method may further comprise: operating as the relay node based on receiving a response signal for the movement report message from the base station.

The method may further comprise: acquiring position information of the aerial relay based on satellite signals received from a plurality of satellites at the first time intervals for the predetermined number of times; and correcting the position information of the aerial relay acquired based on the satellite signals using the estimated position of the aerial relay.

The method may further comprise: acquiring movement direction information of the aerial relay, wherein the report message may further include the movement direction information.

A method of a base station, according to an exemplary embodiment of the present disclosure, may comprise: transmitting, at first time intervals for a predetermined number of times, a pilot signal to each of aerial relays located within coverage of the base station; receiving, at the first time intervals, a report message from each of the aerial relays; determining a position of a first aerial relay based on the report messages; and transmitting, to the first aerial relay, a first message including the position of the first aerial relay, wherein each of the report messages includes a position of each of the aerial relays and a quality of the pilot signal measured by each of the aerial relays.

The predetermined number may be a value preset by the base station through a first link established between the base station and the aerial relays, and the first link may be different from a second link used for one aerial relay among the aerial relays to relay a signal transmitted from the base station to a terminal while the one aerial relay operates as a relay node.

A resource in which the report message is transmitted may be preconfigured through a first link established between the base station and the aerial relays, and the first link may be different from a second link used for one aerial relay among the aerial relays to relay a signal transmitted from the base station to a terminal while the one aerial relay operates as a relay node.

The pilot signal may be transmitted through respective beams that are being swept, and each of the report messages may be received through a beam corresponding to a direction of a beam through which each of the aerial relays receives the pilot signal among the swept beams.

The method may further comprise: receiving, from the first aerial relay, a movement report message including movement completion information of the first aerial relay; and transmitting a response message responding to the movement report message to the first aerial relay.

The method may further comprise: transmitting, to a positioning server of a network, position information of the first aerial relay based on reception of the movement report message of the first aerial relay.

Each of the report messages may further include movement direction information of each of the aerial relays, and the determining of the position of the first aerial relay may further consider the movement direction of the first aerial relay based on the movement direction information.

A method of an aerial relay, according to an exemplary embodiment of the present disclosure, may comprise: estimating, at first time intervals for a predetermined number of times, a position of the aerial relay based on a pilot signal received from a base station; measuring a quality of the received pilot signal whenever the position of the aerial relay is estimated; determining a position at which the aerial relay is to operate as a relay node based on the qualities of the pilot signal measured for the predetermined number of times; transmitting a first message including the determined position to the base station; moving to the determined position in response to receiving a response message from the base station; and operating as the relay node, wherein the aerial relay moves by a predetermined distance at the first time intervals.

The predetermined number may be a value preset by the base station through a first link established between the base station and the aerial relay, and the first link may be different from a second link through which the aerial relay relays a signal transmitted from the base station to a terminal while the aerial relay operates as the relay node.

The position of the aerial relay may be estimated using an angle of arrival (AoA) of the pilot signal received from the base station.

The operating as the relay node may further comprise: transmitting a second message including final position information of the aerial relay to the base station based on movement of the aerial relay; and operating as the relay node based on receiving, from the base station, a response signal responding to the second message.

The method may further comprise: acquiring position information of the aerial relay based on satellite signals received from a plurality of satellites at the first time intervals for the predetermined number of times; and correcting the position information of the aerial relay acquired based on the satellite signals using the estimated position of the aerial relay.

The method may further comprise: acquiring movement direction information of the aerial relay, wherein the report message may further include the movement direction information. According to the present disclosure, since an aerial relay can be operated as a relay node while tracking the position of a counterpart node, communication service can be continuously provided to the counterpart node regardless of changes in the position of the counterpart node.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating a communication network when an aerial relay network is configured.

FIG. 4 is a block diagram illustrating an exemplary embodiment of an aerial relay configured to constitute an aerial relay network.

FIG. 5A is a sequence diagram illustrating a case in which an aerial relay determines whether the aerial relay is to operate as a relay node by using position-related information.

FIG. 5B is a sequence diagram illustrating a case in which an aerial relay determines whether the aerial relay is to operate as a relay node based on a signal quality measurement indicator.

FIG. 6A is a sequence diagram illustrating a case in which a counterpart node determines whether an aerial relay is to operate as a relay node by using position-related information of the aerial relay.

FIG. 6B is a sequence diagram illustrating a case in which a counterpart node determines whether an aerial relay is to operate as a relay node based on a signal quality measurement indicator received from the aerial relay.

FIG. 7 is a sequence diagram illustrating a case in which an aerial relay selects its position using its position information.

FIG. 8A is a portion of a sequence diagram illustrating a case in which a counterpart node determines a position of an aerial relay.

FIG. 8B is the remaining portion of the sequence diagram shown in FIG. 8A.

FIG. 9A is a sequence diagram illustrating a first exemplary embodiment for a case where an aerial relay autonomously determines whether to move while tracking a position of a counterpart node.

FIG. 9B is a sequence diagram illustrating a second exemplary embodiment for a case where an aerial relay autonomously determines whether to move while tracking a position of a counterpart node.

FIG. 10A is a sequence diagram illustrating a first exemplary embodiment for a case where a counterpart node determines whether an aerial relay moves while tracking a position of the counterpart node.

FIG. 10B is a sequence diagram illustrating a second exemplary embodiment for a case where a counterpart node determines whether an aerial relay moves while tracking a position of the counterpart node.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

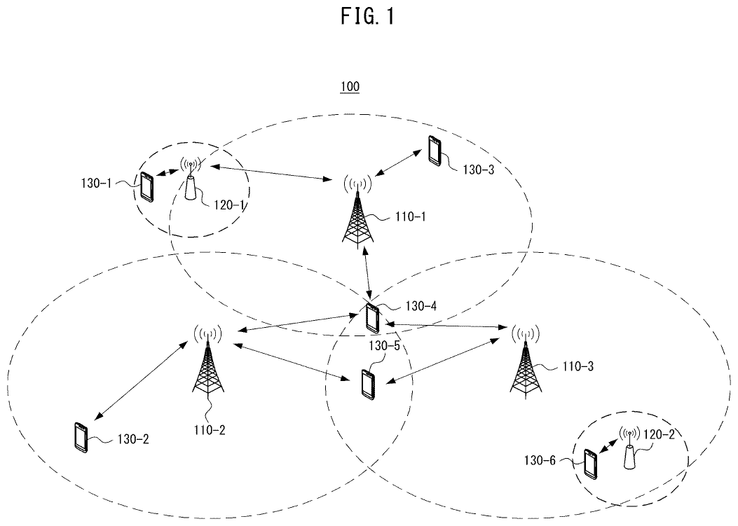

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), etc. specified in the 3rd generation partnership project (3GPP) standards. The 4G communication may be performed in frequency bands below 6 GHz, and the 5G communication may be performed in frequency bands above 6 GHz as well as frequency bands below 6 GHz.

For example, in order to perform the 4G communication and 5G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

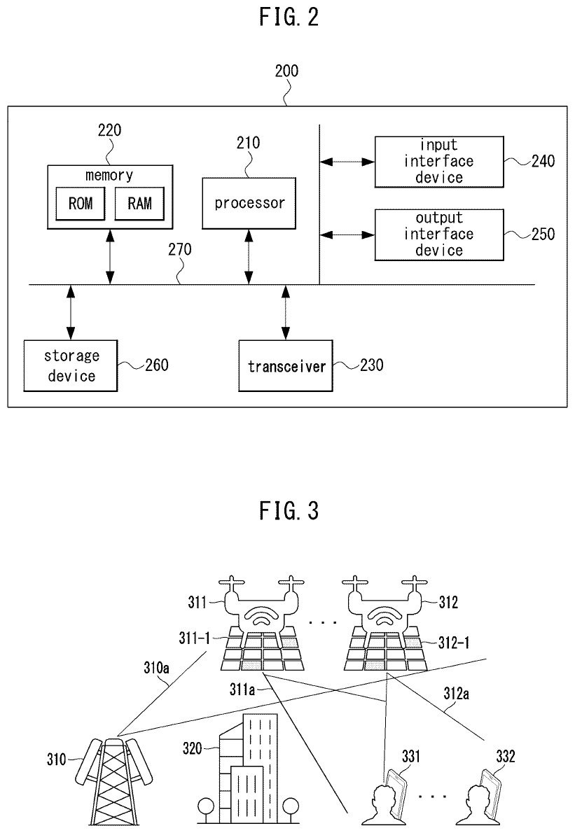

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

In the present disclosure, a phrase including “when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

In the present disclosure described below, a method and apparatus for relaying wireless signals using an aerial mobile platform are described. The aerial mobile platform described below is referred to as an ‘aerial relay’.

FIG. 3 is a conceptual diagram illustrating a communication network when an aerial relay network is configured.

Referring to FIG. 3, an obstacle such as a building 320 may be located between a base station 310 and terminals 331 and 332, and the base station 310 may not be able to directly communicate with the terminals 331 and 332. In such a case, the base station 310 may transmit signals to be transmitted to the terminals 331 and 332 to aerial relays 311 and 312 through a beam 310a or by radiating the signals. In the example of FIG. 3, a case is illustrated in which the base station 310 transmits signals to be transmitted to the terminals 331 and 332 to the aerial relays 311 and 312 through the beam 310a.

Each of the aerial relays 311 and 312 may be an unmanned aerial vehicle (UAV), an urban air mobility (UAM), a high altitude platform station (HAPS), or a satellite payload of a non-terrestrial network (NTN). Each of the aerial relays 311 and 312 described in the present disclosure may include a communication device (not illustrated in FIG. 3) for transmitting and receiving signals and/or a reflector 311-1 or 312-1 for reflecting signals. Each of the reflectors 311-1 and 312-1 may include a passive reconfigurable intelligent surface (RIS), an active RIS, or a network controlled repeater (NCR) controlled by the network.

The passive RIS may be configured with passive elements formed of a two-dimensional metasurface and a processor (not illustrated in FIG. 3) for intelligently reconfiguring the passive elements in real time.

The active RIS may be configured with passive elements, active elements, and a processor (not illustrated in FIG. 3) for intelligently reconfiguring the passive elements and active elements in real time. The passive elements cannot transmit or receive signals because the passive elements do not have a radio frequency (RF) chain, whereas the active elements can transmit and receive signals because the active elements may be connected to an RF chain through switching.

When the aerial relays 311 and 312 use the passive RIS for signaling, each aerial relay (e.g. UAV) may utilize antenna(s) and RF chain(s) embedded in the aerial relay. In addition, when the aerial relays 311 and 312 use the active RIS for signaling, each aerial relay may utilize not only antenna(s) and RF chain(s) embedded in the aerial relay but also active elements. The RIS referred to in the present disclosure may also be referred to as an intelligent reflecting surface (IRS) or a large intelligent surface (LIS). In addition, the NCR may be referred to as a smart repeater.

In the present disclosure described below, methods by which the aerial relay is operated are described. In the present disclosure, three major operating methods for the aerial relay are described.
I. A method for selecting an aerial relay to operate as a relay node among a plurality of aerial relays
II. A method for determining a location of an aerial relay
III. An operating method in which an aerial relay tracks a location of a counterpart node and supports communication

Configurations and operations of a base station and an aerial relay operating according to the above methods are described.

The base station may have the configuration of the communication node described in FIG. 2. In addition, the base station may perform the operations described in FIG. 1. Additionally, the base station may further perform operations according to each exemplary embodiment described below. The operations of the base station are further described in the exemplary embodiments below.

Each of the aerial relays may have a configuration for the three operations exemplified above. Then, the configuration of the aerial relay is first described.

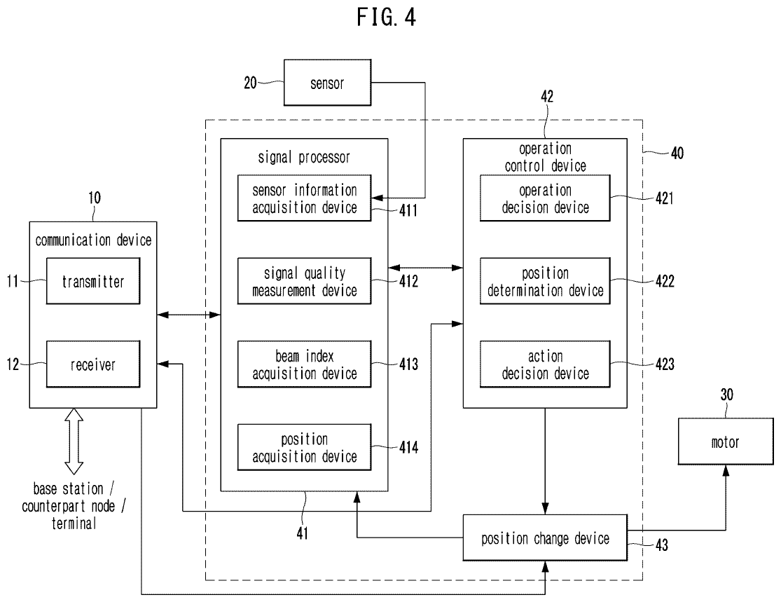

FIG. 4 is a block diagram illustrating an exemplary embodiment of an aerial relay configured to constitute an aerial relay network.

Referring to FIG. 4, the aerial relay may include a communication device 10, a sensor 20, a motor 30, and a processor 40. Although not illustrated in FIG. 4, the aerial relay may further include a power supply device for supplying power to the communication device 10, the sensor 20, the motor 30, and the processor 40. The power supply device may include, for example, one or more rechargeable devices such as a battery or a solar cell.

Although not illustrated in FIG. 4, the aerial relay may further include a memory. The memory may store control information for operating the processor 40 and information for each device included in the aerial relay described below. The memory may include various forms such as a ROM, a RAM, a magnetic disk, or an optical disk.

The above-described component for reflecting signals from the base station is not illustrated in the aerial relay of FIG. 4. The aerial relay may relay signals between the base station and a user, or may provide a communication path between the base station and the user, by using a component for directly reflecting signals received from the base station as-is or for amplifying and reflecting the signals. In all exemplary embodiments of the present disclosure described below, the user may refer to a terminal, a UE, or a mobile terminal carried by the user.

The communication device 10 may include a transmitter 11 and a receiver 12. Although not illustrated in FIG. 4, the communication device 10 may include a plurality of antennas. The communication device 10 may transmit and receive signals between the base station and the aerial relay by using the plurality of antennas. In addition, the communication device 10 may transmit and receive signals with the user by using the plurality of antennas.

The transmitter 11 may operate under the control of the processor 40. For example, the transmitter 11 may transmit signals to the base station, a counterpart node, and/or a terminal based on information received from the processor 40 under the control of the processor 40.

The receiver 12 may convert RF signals received from the base station, the counterpart node, and/or the terminal into baseband signals and provide the baseband signals to the processor 40. For example, the receiver 12 may receive a pilot signal from the base station, another aerial relay, or the user under the control of the processor 40. The receiver 12 may perform low-noise amplification (LNA) on the received signals. The receiver 12 may convert the low-noise amplified signals into baseband signals. The receiver 12 may filter the signals converted into the baseband signals and provide the filtered signals to the processor 40.

The sensor 20 may provide a signal (or information) to the processor 40 for detecting at least one of a position or a speed of the aerial relay. The sensor 20 may include, for example, a receiver for receiving Global Navigation Satellite System (GNSS) signals. The sensor 20 may further include, when necessary, an inertial measurement device configured with a combination of a magnetometer, an accelerometer, or a gyroscope.

The motor 30 may be a device for providing a movement of the aerial relay under the control of the processor 40. For example, the motor 30 may move the aerial relay by supplying power to one or more propellers or supplying power to another type of propulsion device.

The processor 40 may include a signal processor 41, an operation control device 42, and a position change device 43. The internal configuration of the processor 40 illustrated in FIG. 4 may include components functionally separated in order to describe the operations of the present disclosure. Since the internal configuration of the processor 40 may be functionally separated, the respective components may be configured as separate physical devices, or may be configured as software, or may be configured as devices combining physical and software components.

In the present disclosure described below, the processor 40 may have functional components. In the following description, operations between internal components of the processor 40 and/or operations between an internal component of the processor 40 and another component may all be understood as operations of the processor 40 itself. However, it should be noted that in describing the present disclosure, the configuration illustrated in FIG. 4 is used to facilitate understanding of the operations.

The signal processor 41 and the operation control device 42 included in the processor 40 are illustrated as including other plurality of devices. This is for convenience of description, and one or more of the components included in the signal processor 41 and/or the operation control device 42 may be individually configured. In addition, it should be noted that the signal processor 41 and the operation control device 42 may be grouped in another form different from the example of FIG. 4.

The signal processor 41 may include a sensor information acquisition device 411, a signal quality measurement device 412, a beam index acquisition device 413, and a position acquisition device 414.

The sensor information acquisition device 411 may acquire sensing information from the sensor 20 based on control information received from the operation control device 42 or based on a request from another device that requires sensing information. For example, the sensor information acquisition device 411 may receive sensing signals related to a movement speed of the aerial relay, sensing signals related to a movement direction of the aerial relay, and/or GNSS signals from the sensor 20. The sensor information acquisition device 411 may provide the acquired sensing information to the operation control device 42 or to the device that requests the sensing information either in a processed form or as it is.

The signal quality measurement device 412 may measure signal quality of a specific signal received by the communication device 10 based on control information received from the operation control device 42 or based on an instruction from the base station.

In the following description, the specific signal is assumed as a pilot signal. The pilot signal may refer to various forms of signals. For example, the pilot signal may be a reference signal (RS) used in the 5G NR system. In another example, the pilot signal may be configured as a specific sequence such as a preamble sequence and/or a synchronization signal (SS). It should be noted that the pilot signal described in the present disclosure may be in various forms.

The beam index acquisition device 413 may detect a beam index of a received beam based on control information received from the operation control device 42, based on an instruction from the base station, or based on a request from a counterpart node. The received beam may be a beam transmitted from a node capable of performing beamforming toward the receiver 12.

The position acquisition device 414 may acquire or calculate a position of the aerial relay by using GNSS information received from the sensor information acquisition device 411 and/or by using the pilot signal received through the receiver 12 of the communication device 10.

The operation control device 42 may include an operation decision device 421, a position determination device 422, and an action decision device 423.

The operation decision device 421 may collect information received from other devices and may determine whether the aerial relay is to operate as a relay node based on the collected information. Additional operations of the operation decision device 421, including operations for receiving or acquiring information, are described in further detail with reference to sequence diagrams provided later.

The position determination device 422 may collect information received from other devices and may determine a position of the aerial relay based on the collected information. Additional operations of the position determination device 422, including operations for receiving or acquiring information, are also described in further detail with reference to sequence diagrams provided later.

The action decision device 423 may collect information received from other devices and may determine whether the aerial relay is to operate as a relay node and whether the aerial relay is to move based on the collected information. When the action decision device 423 determines whether the aerial relay is to move, the action decision device 423 may provide the determined result to the position change device 43. Additional operations of the action decision device 423, including operations for receiving or acquiring information, are also described in further detail with reference to sequence diagrams provided later.

The position change device 43 may change a position of the aerial relay based on information received from at least one of the communication device, the signal processor 41, or the operation control device 42. When a position change of the aerial relay is required, the position change device 43 may control the motor 30 such that the aerial relay moves to a specific position. After changing the position of the aerial relay, the position change device 43 may deliver (or report) information on the changed position to another device.

Meanwhile, it should be noted that in the configuration of the aerial relay illustrated in FIG. 4, the NCR, the active RIS, and/or the passive RIS are not illustrated, and also that a control device for controlling the NCR, the active RIS, and/or the passive RIS is not illustrated. The aerial relay may reflect signals received from the base station to a user (e.g. user terminal) or may amplify signals received from the base station and may transmit the amplified signals to a user (e.g. user terminal) by using at least one of the NCR, the active RIS, and/or the passive RIS. Further, the aerial relay may reflect or amplify signals transmitted by a user to the base station. For this purpose, the aerial relay needs to control the NCR, the active RIS, and/or the passive RIS to reflect received or incident signals. The control of the NCR, the active RIS, and/or the passive RIS may be performed by the processor 40 illustrated in FIG. 4 or may be performed by a separate processor not illustrated in FIG. 4.

In the present disclosure described below, operations of the aerial relay and operations of a counterpart node are described for each exemplary embodiment. In other words, exemplary embodiments for each of the three methods described above are described. Prior to this, basic operations of the aerial relay are described first.

The aerial relay may transmit and receive signals for system operation with a network (e.g. base station) regardless of whether signals to be relayed exist.

For system operation, configuration information for controlling the aerial relay may be transmitted and received between the aerial relay and the network periodically through signaling between the base station and the aerial relay or when the aerial relay is initially deployed within coverage of the base station. Signaling between the base station and the aerial relay may include at least one of higher layer signaling or physical layer signaling. The higher layer signaling may be, for example, one of radio resource control (RRC) signaling or a medium access control (MAC)-control element (CE) message. A message transmitted through the RRC signaling may be an RRC configuration message or an RRC reconfiguration message.

The aerial relay may operate in a sleep mode or may operate as a relay node. The state of operating as a relay node may be referred to as an active mode. For the operation of the aerial relay, the aerial relay may receive specific signals and/or commands from the network (e.g. base station).

For example, signals received by the aerial relay from the base station may include at least one of a pilot signal transmitted by the base station, an operation command that indicates an operation of the aerial relay, or a signal requesting position and/or speed information of the aerial relay. In addition, signals transmitted by the aerial relay to the network may include at least one of a measurement result of a pilot signal, speed information of the aerial relay, or position information of the aerial relay.

In the present disclosure, communication between the base station and the aerial relay may use a relay link or may use a communication link used between the base station and a terminal in a mobile communication system. Regarding signals transmitted and received between the base station and the aerial relay, necessary technical details are further described in respective exemplary embodiments.

In the description below, it is assumed that the base station is a base station having multiple antennas capable of performing beamforming.

### First Exemplary Embodiment: Method of Selecting an Aerial Relay to Operate as a Relay Node Among Multiple Aerial Relays

In the first exemplary embodiment of the present disclosure, methods of selecting or determining an aerial relay to be used to provide smooth communication services to a user among multiple aerial relays are described.

An environment may be considered in which one or two or more aerial relays are deployed within coverage of one base station. In the first exemplary embodiment described below, a case is described in which two or more aerial relays are deployed within coverage of one base station. However, even when only one aerial relay is located within coverage of a base station, the same or a similar procedure described below may be used. In the present disclosure, the base station is described assuming a terrestrial base station located on the ground. However, when a satellite is equipped with or mounted with a part or all of base station functions of an NTN, the base station may refer to the satellite.

An aerial relay in the active mode may provide communication services through relaying between the base station and a specific user. Alternatively, the aerial relay in the active mode may provide communication services to a user by relaying signals between a neighboring aerial relay and the base station. Among aerial relays, an aerial relay that does not operate as a relay node may operate in the sleep mode.

The aerial relay may transmit and receive signals for system operation to and from the base station and/or another aerial relay regardless of relaying signals. In other words, even when the aerial relay is in the sleep mode, the aerial relay may transmit and receive signals for system operation with the base station and/or another aerial relay. The signals for system operation may include at least one of a pilot signal, position information, or a signal quality measurement value.

According to the first exemplary embodiment of the present disclosure, one or more aerial relays operating in the sleep mode may transition from the sleep mode to the active mode to replace another aerial relay for relaying communication services or to move to a specific position for emergency support.

In the first exemplary embodiment of the present disclosure, a method of determining whether an aerial relay is to operate as a relay node is described.

For example, the aerial relay may autonomously determine whether the aerial relay is to operate as a relay node. In another example, whether the aerial relay is to operate as a relay node may be determined by the network (e.g. base station).

### A. Method in Which an Aerial Relay Autonomously Determines Whether the Aerial Relay is to Operate as a Relay Node

When whether an aerial relay is to operate as a relay node is determined by the aerial relay itself, the aerial relay may determine whether the aerial relay is to operate as a relay node based on signaling with a counterpart node. In this case, the counterpart node may include at least one of a base station that supports the aerial relay or another aerial relay connected through a communication link.

Each aerial relay operating within coverage of the base station may autonomously determine whether the aerial relay is to operate as a relay node when specific conditions are satisfied. Specific conditions for autonomously determining whether the aerial relay is to operate as a relay node may be preconfigured by the base station. The specific conditions may be, for example, a specific time duration. Another example of the specific conditions may be a case in which the aerial relay is located in a shadow area of the base station. The specific conditions may be configured variously as described above. Hereinafter, exemplary embodiments for a case in which the aerial relay autonomously determines whether the aerial relay is to operate as a relay node are described with reference to the accompanying drawings.

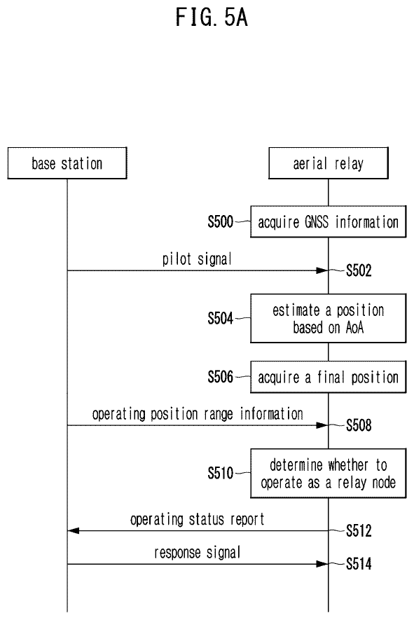

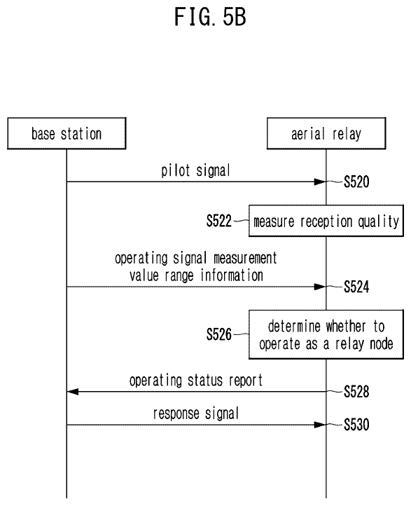

FIG. 5A is a sequence diagram illustrating a case in which an aerial relay determines whether the aerial relay is to operate as a relay node by using position-related information.

In step S500, the aerial relay may acquire GNSS information. The GNSS information may be acquired regardless of whether the aerial relay operates as a relay node, as described above. Therefore, even when the aerial relay is in the sleep mode, the aerial relay may acquire GNSS information according to a preset periodicity. The preset periodicity may be determined based on one or more pieces of information among a remaining battery capacity of the aerial relay, mobility of the aerial relay, or a range between a minimum periodicity and a maximum periodicity preset by the base station. When the aerial relay is in the active mode, the aerial relay may also acquire GNSS information according to a preset periodicity. In this case, the preset periodicity may be determined based on the information described above.

When a minimum periodicity and/or a maximum periodicity at which the aerial relay needs to acquire GNSS information is set by the base station, information on the minimum periodicity and/or maximum periodicity at which the aerial relay needs to acquire GNSS information may be transmitted in advance from the base station to the aerial relay through a higher layer message between the base station and the aerial relay. In addition, when the base station provides specific configuration information to the aerial relay through an RRC configuration message or an RRC reconfiguration message, operating position range information transmitted in step S508 described below may be transmitted together through the RRC configuration message or the RRC reconfiguration message. It should be noted that a case in which such configuration information is transmitted in advance from the base station to the aerial relay is not illustrated in FIG. 5A.

More specifically, the GNSS information may be acquired by the sensor information acquisition device 411 based on signals received from satellites through the sensor 20. The sensor information acquisition device 411 may provide the acquired GNSS information to the position acquisition device 414. The position acquisition device 411 may calculate or estimate the position of the aerial relay by using the GNSS information. A method of calculating the position of the aerial relay by the position acquisition device 411 using the GNSS information may be performed based on signals received from four or more satellites in general. Since a position calculation method using GNSS information is a widely known technique, a description of the position calculation method using GNSS information is omitted in the present disclosure.

In step S502, the aerial relay may receive a pilot signal from the base station. The pilot signal may be received through the receiver 12 included in the communication device 10. The receiver 12 may convert the received pilot signal into a baseband signal and may provide the baseband signal to the position acquisition device 414.

In step S504, the aerial relay may estimate the position of the aerial relay by using an angle of arrival (AoA) of the received pilot signal. More specifically, the position acquisition device 414 may receive the pilot signal converted into the baseband signal from the receiver 12. In addition, the position acquisition device 414 may already know the number and/or arrangement of receive antennas used by the receiver 12. Therefore, the position acquisition device 414 may estimate the position of the aerial relay by using phase differences between signals received through the respective antennas.

In step S506, the aerial relay may determine a final position of the aerial relay by using the GNSS information and the position estimated based on the AoAs. More specifically, the position acquisition device 414 may determine the final position of the aerial relay by using the position information based on the acquired GNSS information and the position information estimated based on the AoAs. The position acquisition device 414 may provide information on the final position of the aerial relay to the operation decision device 421.

In step S508, the aerial relay may receive operating position range information from the base station. More specifically, the receiver 12 may convert the operating position range information received from the base station into a baseband signal and may provide the baseband signal to the operation decision device 421.

The operating position range information may be information that designates a geographical range in which the aerial relay operates as a relay node. The geographical range may be expressed in various forms. For example, a range in which the aerial relay needs to operate as a relay node may be designated by using coordinates of one point (e.g. coordinates of latitude and longitude) and a radius. In such a case, a circular geographical range corresponding to the radius from the designated coordinates may be configured as the range in which the aerial relay needs to operate as a relay node.

In another example, the range in which the aerial relay needs to operate as a relay node may be designated based on coordinates of three or more different points. For example, when coordinates of three points are configured, an internal region of a triangle connecting the three points may become the geographical range. When coordinates of five or more points are provided, an internal region of a pentagon connecting the five points may become the geographical range.

In yet another example, when two or more points and radii corresponding to the respective points are provided, an overlapping region of circles generated based on the respective points and corresponding radii and/or a union of the circles may be designated as a range in which the aerial relay needs to operate as a relay node. When coordinates and radii for representing two or more circles are provided, the geographical range may be configured more precisely.

Meanwhile, in the example of FIG. 5A, a case is assumed in which a step of receiving the operating position range information of the aerial relay is performed after receiving the pilot signal. However, it should be noted that the operating position range information of the aerial relay may be configured in advance as described above.

In step S510, the aerial relay may determine whether the aerial relay is to operate based on the operating position range information and the determined final position of the aerial relay. The operation decision device 421 may determine that the aerial relay is to operate as a relay node when the position of the aerial relay based on the final position information is located within the geographical range indicated by the operating position range information. In contrast, the operation decision device 421 may determine that the aerial relay is not to operate as a relay node when the position of the aerial relay based on the final position information is located outside the geographical range indicated by the operating position range information.

In step S512, the aerial relay may transmit an operating status report message to the base station. The operating status report message may include information indicating that the aerial relay operates as a relay node or information indicating that the aerial relay does not operate as a relay node. The operation decision device 421 may provide the operating status report message including information indicating the operating status to the transmitter 11. The transmitter 11 may perform an up-conversion of the operating status report message into an RF band and may transmit the RF-band signal to the base station through antenna(s). In this case, when a paired beam between the aerial relay and the base station exists, the transmitter 11 may transmit the operating status report message to the base station by using the paired beam.

Accordingly, in step S512, the base station may receive the operating status report message from the aerial relay. The base station may identify whether the aerial relay is to operate as a relay node or is not to operate as a relay node based on operating indication information included in the operating status report message received from the aerial relay.

In step S514, the base station may transmit a response message to the aerial relay in response to the reception of the operating status report message. Accordingly, in step S514, the aerial relay may receive the response to the operating status report message from the base station. When the aerial relay determines to operate as a relay node, the aerial relay may operate as a relay node based on reception of the response signal from the base station.

According to the exemplary embodiment of FIG. 5A described above, the aerial relay may autonomously determine whether the aerial relay is to operate as a relay node. However, whether the aerial relay autonomously operates as a relay node needs to be pre-authorized by the base station and the aerial relay needs to satisfy conditions configured by the base station. In addition, to identify whether conditions configured by the base station are satisfied, the aerial relay may determine whether the aerial relay is to operate as a relay node by using acquired position information obtained by using the sensor included in the aerial relay and/or by using estimated position information obtained by using signals (e.g. pilot signals) received from the base station.

According to the exemplary embodiment of FIG. 5A, the aerial relay may autonomously determine whether the aerial relay is to operate as a relay node without receiving information of another aerial relay, and therefore the aerial relay may determine whether the aerial relay is to operate as a relay node more rapidly compared to a case in which a counterpart node determines whether the aerial relay is to operate as a relay node.

FIG. 5B is a sequence diagram illustrating a case in which an aerial relay determines whether the aerial relay is to operate as a relay node based on a signal quality measurement indicator.

In step S520, the base station may transmit a pilot signal to the aerial relay. Accordingly, in step S520, the aerial relay may receive the pilot signal from the base station. When a beam paired in advance between the base station and the aerial relay exists, the pilot signal may be transmitted through the paired beam. When a paired beam does not exist, the base station may broadcast the pilot signal.

The receiver 12 of the aerial relay may convert the pilot signal received from the base station into a baseband signal. The receiver 12 may provide the pilot signal converted into the baseband signal to the signal quality measurement device 412.

In step S522, the aerial relay may measure a reception quality of the received pilot signal. More specifically, the signal quality measurement device 412 may measure a signal quality of the received pilot signal. Here, the signal quality may be represented as one of received signal strength (RSS), signal-to-noise ratio (SNR), signal to interference plus noise ratio (SINR), channel quality, or signal quality, for example. The signal quality measurement device 412 may provide the measured signal quality to the operation decision device 421.

In step S524, the base station may transmit operating signal quality measurement value range information to the aerial relay. Accordingly, in step S524, the aerial relay may receive the operating signal quality measurement value range information from the base station. The receiver 12 of the aerial relay may convert the operating signal quality measurement value range information received from the base station into a baseband signal and then may provide the baseband signal to the operation decision device 421.

As previously described in FIG. 5A, when the base station is able to transmit a higher layer message to the aerial relay, the operating signal quality measurement value range information may be transmitted in advance to the aerial relay. In this case, the higher layer message may be one of an RRC configuration message, an RRC reconfiguration message, or a MAC-CE message, as described above. However, it should be noted that FIG. 5B illustrates, for convenience of description of the present disclosure, a case in which the operating signal quality measurement value range information is transmitted in step S524.

In step S526, the aerial relay may determine whether the aerial relay is to operate as a relay node based on the measured reception quality and the operating signal quality measurement value range information received from the base station. More specifically, the operation decision device 421 may determine whether the aerial relay is to operate as a relay node based on the reception quality of the pilot signal measured by the signal quality measurement device 412 and the operating signal quality measurement value range information received from the base station. The operation decision device 421 may generate an operating status report message including information indicating whether the aerial relay is to operate as a relay node. The generated operating status report message may be provided to the transmitter 11.

In step S528, the transmitter 11 of the aerial relay may transmit the operating status report message to the base station. More specifically, the transmitter may up-convert the operating status report message into an RF band and may transmit the RF band signal to the base station through antenna(s). In this case, when a paired beam exists between the base station and the aerial relay, the operating status report message may be transmitted through the paired beam.

Accordingly, in step S528, the base station may receive the operating status report message from the aerial relay. The base station may identify whether the aerial relay is to operate as a relay node based on operating indication information included in the operating status report message.

In step S530, the base station may transmit a response signal to the aerial relay in response to receiving the operating status report message. Accordingly, in step S530, the aerial relay may receive the response signal from the base station.

When the aerial relay determines to operate as a relay node, the aerial relay may operate as a relay node based on reception of the response signal from the base station.

According to the exemplary embodiment of FIG. 5B described above, the aerial relay may autonomously determine whether the aerial relay is to operate as a relay node. However, whether the aerial relay is to autonomously operate as a relay node needs to be pre-authorized by the base station and the aerial relay needs to satisfy conditions configured by the base station. In addition, to identify whether conditions configured by the base station are satisfied, the aerial relay may determine whether the aerial relay is to operate as a relay node based on the quality of the pilot signal received from the base station.

In the exemplary embodiment of FIG. 5B, the aerial relay may determine whether the aerial relay is to operate as a relay node without receiving information of another aerial relay, and therefore the aerial relay may determine whether the aerial relay is to operate as a relay node more rapidly compared to a case in which a counterpart node determines whether the aerial relay is to operate as a relay node.

Meanwhile, FIG. 5A and FIG. 5B have been described separately as respective exemplary embodiments. However, FIG. 5A and FIG. 5B may be considered together. In other words, when determining whether an aerial relay is to operate as a relay node, the aerial relay may consider both the position of the aerial relay and the reception quality from the base station. Such a modified example may be performed based on the descriptions of FIG. 5A and FIG. 5B described above.

### B. Method in Which a Counterpart Node Determines Whether an Aerial Relay is to Operate as a Relay Node

Each aerial relay operating within coverage of a base station may be controlled to operate as a relay node by a counterpart node. Here, the counterpart node may be a base station or another aerial relay. Hereinafter, a case is described in which the counterpart node is a base station.

The counterpart node may receive information acquired by the aerial relay from the aerial relay to determine whether the aerial relay is to operate as a relay node. In other words, the aerial relay may transmit information necessary for determining whether the aerial relay is to operate as a relay node to the counterpart node. In this case, the information acquired by the aerial relay may be information acquired through the sensor or information acquired based on signals received from the counterpart node. Hereinafter, exemplary embodiments in which a counterpart node determines whether an aerial relay is to operate as a relay node are described with reference to the accompanying drawings.

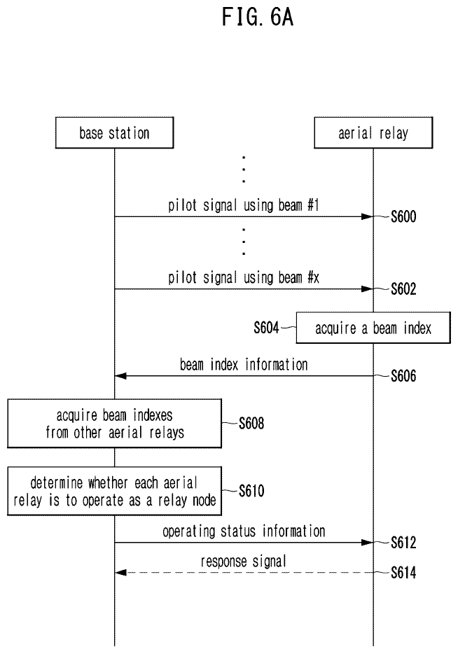

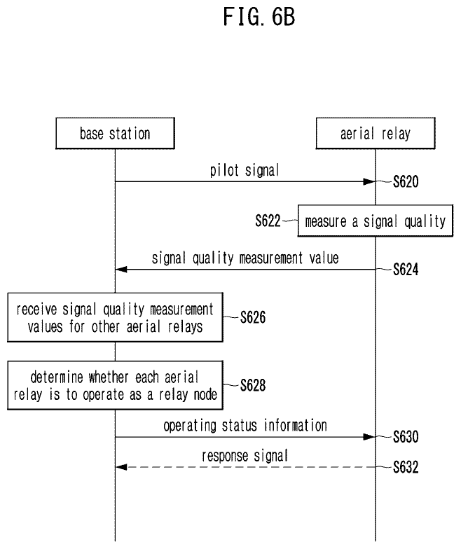

FIG. 6A is a sequence diagram illustrating a case in which a counterpart node determines whether an aerial relay is to operate as a relay node by using position-related information of the aerial relay.

In step S600, a base station may transmit a specific signal (e.g. pilot signal) to an aerial relay by using a beam #1. In the present disclosure, the specific signal is assumed as a pilot signal. The beam #1 may be a beam transmitted in a specific direction. Therefore, when the aerial relay is located in the direction of the beam #1, the aerial relay may receive the beam #1 formed by the base station. In contrast, when the aerial relay is not located in the direction of the beam #1, the aerial relay may not receive the beam #1 formed by the base station.

In the present disclosure, a case is assumed in which the base station sequentially transmits a plurality of beams by performing beam sweeping. However, when the base station is able to form a plurality of beams in all directions simultaneously, steps S600 and S602 described below may be performed simultaneously.

FIG. 6A illustrates an example of a case in which the aerial relay is not located in the direction of the beam #1 formed by the base station. Although not illustrated in FIG. 6A, the base station may subsequently transmit the pilot signal by using a beam #2 formed by the base station. When the number of beams that the base station can form is N, the base station may sequentially transmit beams #1, #2, #3, . . . #x, . . . and #N by performing beam sweeping in sequence.

In step S602, the base station may transmit the pilot signal to the aerial relay by using the beam #x. The example of FIG. 6A may be an example assuming that the aerial relay is located in the direction of the beam #x formed by the base station. The example of FIG. 6A may correspond to a case in which other beams transmitted by the base station through beam sweeping are not illustrated.

In step S602, the aerial relay may receive the pilot signal from the base station through the beam #x. The receiver 12 of the aerial relay may receive the pilot signal through the beam #x formed by the base station and may convert the received pilot signal into a baseband signal. The receiver 12 may deliver the pilot signal converted into the baseband signal to the beam index acquisition device 413.

In an actual wireless environment, when the base station transmits a plurality of beams by performing beam sweeping, the aerial relay may receive two or more beams. In the exemplary embodiment of FIG. 6A, it should be noted that, for convenience of description and understanding, only a beam having the largest received signal strength of the pilot signal among pilot signals received through the two or more received beams is illustrated.

In step S604, the beam index acquisition device 413 of the aerial relay may acquire a beam index of the beam through which the pilot signal is transmitted in step S602. For example, the beam index may be information mapped based on a sequence of the pilot signal. In other words, when the pilot signal is configured with a specific sequence, the beam index acquisition device 413 may acquire the beam index based on the sequence of the received pilot signal.

In another example, when the pilot signal is a synchronization signal block (SSB) used in 5G NR, the beam index acquisition device 413 may acquire the beam index in a form similar or identical to a procedure of acquiring a beam index by identifying SSB in 5G NR. The beam index acquisition device 413 may deliver information on the acquired beam index to the transmitter 11.

In step S606, the transmitter 11 of the aerial relay may transmit information on the beam index to the base station. In other words, the transmitter 11 may up-convert a report message including the beam index received from the beam index acquisition device 413 into an RF band and may transmit the RF-band report message to the base station through antenna(s). When reciprocity of beams between the aerial relay and the base station is established, the aerial relay may form a beam in the direction from which the pilot signal is received and may transmit the information on the beam index to the base station through the beam.

A radio resource for transmitting the report message including the information on the beam index may be preconfigured for each aerial relay by a higher layer message (e.g. an RRC message or a MAC-CE message). In another example, although not illustrated in FIG. 6A, the radio resource for transmitting beam index information and a message instructing the transmission of the beam index information may be transmitted to the aerial relay through a physical layer channel (e.g. a physical downlink control channel (PDCCH) or a specific control channel of a relay link) before step S600. Accordingly, the base station may receive the beam index information through the radio resource pre-allocated for the aerial relay.

In step S608, the base station may also acquire beam indexes from other aerial relays. Although FIG. 6A illustrates, for convenience of description and understanding, the procedure in which the base station acquires beam indexes from other aerial relays as a single step (step S608), this is merely a simplified example. In practice, in step S608, the procedure in which the base station acquires a beam index from each of other aerial relays may be performed through steps S600 to S606. In addition, when three or more aerial relays exist within coverage of the base station, step S608 may be repeatedly performed ‘a total number of aerial relays—1’ times. In other words, the base station may receive information on a beam index from each of a plurality of aerial relays.

In step S610, the base station may identify a distribution of the aerial relays based on the beam indexes received from the aerial relays. In other words, the base station may identify in which directions the aerial relays within coverage of the base station are located. Based on the identified positions of the aerial relays, the base station may determine which aerial relay located in a particular direction is to operate as a relay node. The base station may generate an operation message indicating whether each aerial relay is to operate as a relay node.

In step S612, the base station may transmit operating status information to the aerial relay. In this case, the operating status information may be transmitted in a beam direction corresponding to the beam #x through which the aerial relay transmitted the beam index information. Accordingly, in step S612, the aerial relay may receive the operating status information through the beam in the same direction as the beam corresponding to the direction in which beam #x was received (or a beam having a different width in the same direction). The receiver 12 of the aerial relay may receive the operating status information, may convert the operating status information into a baseband signal, and may deliver the baseband signal to the operation decision device 421. The operation decision device 421 may, based on the received operating status information, determine that the aerial relay operates as a relay node or may control the aerial relay to operate in the sleep mode.

Since FIG. 6A corresponds to a sequence diagram between the base station and one aerial relay, the operating status information is illustrated as being transmitted only to one aerial relay illustrated in FIG. 6A. However, the base station may transmit the operating status information to the plurality of aerial relays from which the beam indexes are received. In addition, the base station may configure and transmit the operating status information such that two or more aerial relays among the plurality of aerial relays operate as relay nodes. The cases in which the base station determines that the aerial relay operates as a relay node may include a case in which a region between the base station and a user is a shadow area due to an obstacle, a case in which a user-dense region exists, a case in which a small cell (e.g. femto-cell) connected to the base station is faulty, or a case in which replacement of an aerial relay is required, as described above with reference to FIG. 3.

When necessary, the operation decision device 421 may generate a response signal and may deliver the response signal to the transmitter 11. The case in which the operation decision device 421 delivers the response signal to the transmitter 11 may correspond to a case in which the aerial relay is to operate as a relay node.

In step S614, the transmitter 11 of the aerial relay may up-convert the response message into an RF band and may transmit the RF-band response message to the base station by using antenna(s). In this case, when reciprocity of beams between the base station and the aerial relay is established as described above, the response signal may be transmitted in the beam direction in which the operating status information is received. By providing step S614, the base station has an advantage of being able to confirm whether the corresponding aerial relay is to operate as a relay node based on the operating status information.

Compared with the exemplary embodiment of FIG. 6A described above and cases in which the aerial relay autonomously determines whether to operate as a relay node as described with reference to FIGS. 5A and 5B, since the network (e.g. base station) determines the operating status of the aerial relay by using information (positions or direction distribution) of aerial relays received from the aerial relays, the network has an advantage of being able to determine the operating status of the aerial relay from the perspective of the entire network. In particular, since the network (e.g. base station) may consider a status of resources (frequency resources, time resources, and space resources) owned by the network, a distribution state of users, geographical environments, and the like, the network may determine the operating status of the aerial relay more effectively.

FIG. 6B is a sequence diagram illustrating a case in which a counterpart node determines whether an aerial relay is to operate as a relay node based on a signal quality measurement indicator received from the aerial relay.

In step S620, the base station may transmit a pilot signal to an aerial relay. The pilot signal transmitted by the base station may be transmitted through respective beams at a preset periodicity set by a higher layer message (e.g. an RRC message or a MAC-CE message) between the base station and the aerial relay. The base station may perform beam sweeping with the beams transmitting the pilot signal. Therefore, step S620 may be performed in the same manner as steps S600 to S602 described in FIG. 6A.

The receiver 12 of the aerial relay may receive the pilot signal transmitted from the base station in step S620. When the aerial relay is in the active mode, since the aerial relay is aware of a beam through which the base station transmits the pilot signal, the aerial relay may receive the pilot signal through the corresponding beam. On the other hand, if the aerial relay is in the sleep mode, the aerial relay may measure the pilot signal transmitted through each of a plurality of beams as described above in FIG. 6A. In this case, as assumed in FIG. 6A, it should be noted that the exemplary embodiment of FIG. 6B is also illustrated, for the convenience of description and understanding, only for a beam corresponding to the pilot signal having the greatest received signal strength.

The receiver 12 may convert the received pilot signal into a baseband signal. The receiver 12 may deliver the pilot signal converted into a baseband signal to the signal quality measurement device 412.

In step S622, the signal quality measurement device 412 of the aerial relay may measure a signal quality of the received pilot signal. The signal quality measurement device 412 may generate a signal quality measurement value for the measured pilot signal. The signal quality measurement device 412 may deliver a report message including the signal quality measurement value to the transmitter 11.

In step S624, the transmitter 11 of the aerial relay may up-convert the report message including the signal quality measurement value to an RF band and may transmit the report message to the base station through antenna(s). When reciprocity of beams between the aerial relay and the base station is established, the aerial relay may form a beam in the direction from which the pilot signal is received and may transmit information on a beam index to the base station.

When the base station preconfigures, before step S620, reporting of the signal quality measurement value to the aerial relay through a higher layer message (e.g. an RRC message or a MAC-CE message), the report message including the signal quality measurement value may be transmitted by the aerial relay in step S624. In another example, although not illustrated in FIG. 6B, the radio resource for transmitting the signal quality measurement value and a message instructing the transmission of the signal quality measurement value may be transmitted to the aerial relay through a physical layer channel (e.g. a PDCCH or a specific control channel of a relay link) before step S620. Accordingly, in step S624, the base station may receive the signal quality measurement value through the resource pre-allocated for the aerial relay.

In step S626, the base station may also acquire signal quality measurement values from other relays. Although FIG. 6B illustrates, for convenience of description and understanding, the procedure in which the base station acquires signal quality measurement values from other aerial relays as a single step (step S626), this is merely a simplified example. In practice, in step S626, the procedure in which the base station acquires a signal quality measurement value from each of other aerial relays may be performed through steps S620 to S624. In addition, when three or more aerial relays exist within coverage of the base station, step S626 may be repeated multiple times. In other words, the signal quality measurement value may be acquired from each of the plurality of aerial relays.

In step S628, the base station may identify a channel state between each of the aerial relays and the base station based on the signal quality measurement value received from each of the aerial relays. The base station may determine operation of each of the aerial relays based on the channel state between each of the aerial relays and the base station.

In step S630, the base station may transmit operating status information to the aerial relay. In step S630, the aerial relay may receive the operating status information from the base station. In this case, the operating status information may be transmitted through a beam in the same beam direction as the pilot signal transmitted by the base station.

In step S630, the receiver 12 of the aerial relay may receive the operating status information from the base station through the beam in the same direction as the direction in which the pilot signal is received. The receiver 12 may convert the operating status information into a baseband signal and may transmit the baseband signal to the operation decision device 421. The operation decision device 421 may determine that the aerial relay is to operate as a relay node or may control the aerial relay to operate in the sleep mode based on the received operating status information.

Since the exemplary embodiment of FIG. 6B corresponds to a sequence diagram between the base station and one aerial relay, the operating status information is illustrated as being transmitted only to one aerial relay illustrated in FIG. 6B. However, the base station may transmit the operating status information to a plurality of aerial relays from which the beam indexes are received. In addition, the base station may configure and transmit the operating status information to cause two or more aerial relays among the plurality of aerial relays to operate as relay nodes. The cases in which the base station determines that the aerial relay operates as a relay node may include a case in which a region between the base station and a user is a shadow area due to an obstacle, a case in which a user-dense region exists, a case in which a small cell (e.g. femto-cell) connected to the base station is faulty, or a case in which replacement of an aerial relay is required, as described above with reference to FIG. 3.

When necessary, the operation decision device 421 may generate a response signal and may deliver the response signal to the transmitter 11. The case in which the operation decision device 421 delivers the response signal to the transmitter 11 may correspond to a case in which the aerial relay is to operate as a relay node.

In step S632, the transmitter 11 of the aerial relay may up-convert the response message to an RF band and may transmit the response message to the base station using antenna(s). In this case, when reciprocity of beams between the base station and the aerial relay is established as described above, the response signal may be transmitted in the beam direction in which the operating status information is received.

Compared to the exemplary embodiment of FIG. 5A and FIG. 5B described above, in the exemplary embodiment of FIG. 6B, the network (e.g. base station) determines the operating status of the aerial relay using information received from the aerial relays (i.e. signal quality measurement information). Therefore, the network may determine the operating status of the aerial relay from the perspective of the entire network. In particular, since the network (e.g. base station) may consider a status of resources (frequency resources, time resources, and space resources) owned by the network, a distribution state of users, and geographical environments, the network may determine the operating status of the aerial relay more effectively.

Meanwhile, FIG. 6A and FIG. 6B have been described separately as respective exemplary embodiments. However, FIG. 6A and FIG. 6B may also be considered together. In other words, when the base station determines whether the aerial relay is to operate as a relay node, the base station may identify a distance from the base station based on the position (direction from the base station) of the aerial relay and a quality measurement value of a signal received from the base station. Therefore, if FIG. 6A and FIG. 6B are considered together, since the base station may more accurately identify the position of the aerial relay as well as distribution of the aerial relays, the base station may more efficiently determine the operating status of the aerial relay in terms of the network.

According to the first exemplary embodiment described above, when determining whether to operate the aerial relay as a relay node, the aerial relay may determine the operating status directly or the network (e.g. base station) may determine the operating status. In the first exemplary embodiment of the present disclosure, criteria for determining the operating status of the aerial relay may be the position of the aerial relay and/or the quality measurement indicator measured based on the pilot signal.

To acquire the position of the aerial relay, the present disclosure described, as examples, GNSS information obtained by the aerial relay, position information obtained from AoAs estimated based on the pilot signals received by the aerial relay, and beam indexes obtained from the pilot signals. However, although not described in the present disclosure, it may also be possible to acquire the position of the aerial relay using time difference of arrivals (TDoAs). In addition, various information capable of acquiring the position of the aerial relay may further be utilized. When only GNSS is used, AoA and/or TDoA may be used together to compensate for uncertainty of GNSS due to jitter.

In addition, the pilot signal described in the first exemplary embodiment may be an SS used in 5G NR, and the indicator representing the signal quality may be one or more of an SS-reference signal received power (SS-RSRP), an SS-reference signal received quality (SS-RSRQ), a CSI-RSRQ, an SS-SINR, a CSI-SINR, or a received signal strength indicator (RSSI).

Among the signal quality measurement indicators described above, the signal quality measurement indicator(s) to be used in the aerial relay may be configured to the aerial relay by the base station in advance using a higher layer message (e.g. an RRC message, a MAC-CE message, or a combination of these) and/or a message using a physical layer channel. In another example, the signal quality measurement indicator(s) to be used by the aerial relay may be preconfigured depending on a configuration of the aerial relay. In another example, when a network operator initially deploys the aerial relay, the signal quality measurement indicator(s) to be used may be configured.

### Second Exemplary Embodiment: Method of Selecting a Position of an Aerial Relay

The aerial relay according to the present disclosure may receive a signal to be transmitted from a base station to a user (i.e. user terminal) and may amplify and forward the signal. In another example, the aerial relay may reflect the signal to be transmitted from the base station to the user (i.e. user terminal) to the user (i.e. user terminal) by using at least one of a passive RIS, an active RIS, and an NCR. Therefore, the aerial relay needs to be located at an appropriate position between the base station and the user in order to smoothly transmit (or reflect, or amplify and reflect) the signal from the base station to the user or from the user to the base station. In particular, when selecting the position of the aerial relay, the signal received from the base station to the aerial relay may be one of important factors.

Therefore, the second exemplary embodiment below describes a method in which the position of the aerial relay is selected based on a signal quality between the base station and the aerial relay. The aerial relay may determine the position through signaling with a counterpart node. The counterpart node may include a base station supporting the aerial relay or another aerial relay connected through a link between aerial relays.

As described above in the first exemplary embodiment, the aerial relay may receive a signal for system operation from the network, regardless of whether the aerial relay operates as a relay node. The signal for system operation may be, for example, a pilot signal and/or a signal for acquiring position information. In addition, as described above, the pilot signal may be a signal such as SS, SSB, or reference signal for channel state measurement (CSI-RS).

In addition, as in the first exemplary embodiment described above, the aerial relay may select its position by itself (autonomously) or the counterpart node (e.g. base station) may select the position of the aerial relay at the time of position selection of the aerial relay in the second exemplary embodiment.

### A. Method in Which an Aerial Relay Autonomously Determines its Position

Hereinafter, an exemplary embodiment for a case in which the aerial relay autonomously selects its position is described with reference to the accompanying drawings.

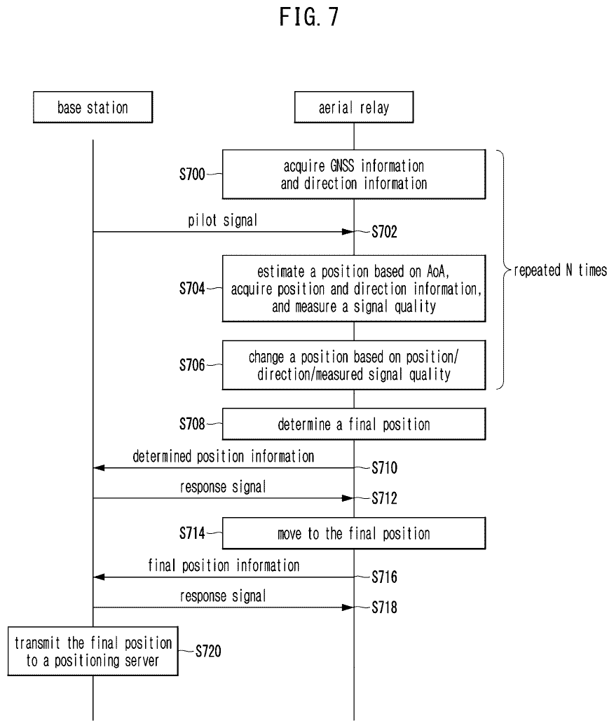

FIG. 7 is a sequence diagram illustrating a case in which an aerial relay selects its position using its position information.

In step S700, the aerial relay may acquire GNSS information. The GNSS information may be acquired regardless of whether the aerial relay operates as a relay node as described above. Therefore, even when the aerial relay is in the sleep mode, the aerial relay may acquire GNSS information at a preset periodicity. The preset periodicity may be determined based on one or more pieces of information among a remaining battery capacity of the aerial relay, mobility of the aerial relay, or a range between a minimum periodicity and a maximum periodicity preset by the base station. When the aerial relay is in the active mode, the aerial relay may acquire GNSS information at a preset periodicity. In this case, the preset periodicity may be determined based on the information described above.

In addition, as described in the first exemplary embodiment, when the base station configures a minimum periodicity and/or a maximum periodicity at which the aerial relay needs to acquire GNSS information, the minimum periodicity and/or the maximum periodicity at which GNSS information needs to be acquired may be transmitted in advance by the base station to the aerial relay through a higher layer message (e.g. an RRC message or a MAC-CE message) between the base station and the aerial relay.

In step S700, the GNSS information may be acquired by the sensor information acquisition device 411 based on signals received from satellites through the sensor 20. The sensor information acquisition device 411 may provide the acquired GNSS information to the position acquisition device 414. When the sensor 20 further includes an inertial measurement device combining a magnetometer, an accelerometer, and/or a gyroscope, direction information of the aerial relay may further be provided to the position acquisition device 414. The position acquisition device 414 may calculate (or estimate) a position of the aerial relay using the GNSS information and/or the direction information of the aerial relay.

In step S702, the base station may transmit a specific signal (e.g. pilot signal) to the aerial relay at a preset periodicity or based on information configured between the base station and the aerial relay. Therefore, in step S702, the receiver 12 of the aerial relay may receive the pilot signal from the base station. The receiver 12 may convert the received pilot signal to a baseband signal and may provide the baseband signal to the position acquisition device 414 and the signal quality measurement device 412.

In step S704, the position acquisition device 414 of the aerial relay may receive the pilot signal converted into the baseband signal from the receiver 12, and may estimate the position of the aerial relay by using phase differences between the pilot signals incident to respective antennas of the communication device. The position acquisition device 414 may provide, to the position determination device 422, position information of the aerial relay based on GNSS signals, direction information of the aerial relay acquired from the inertial measurement device, and information on the position of the aerial relay estimated using the pilot signals.

In addition, the signal quality measurement device 412 may receive the pilot signal converted into the baseband signal from the receiver 12, and may measure a signal quality of the received pilot signal. The signal quality measurement device 412 may provide the measured signal quality measurement value to the position determination device 422.

In step S706, the position determination device 422 of the aerial relay may determine information indicating a target position to which the aerial relay needs to move from a current position based on the GNSS information received from the sensor information acquisition device 411 and/or the direction information and the signal quality measurement value received from the signal quality measurement device 412. In the description below, information indicating a target position to which the aerial relay is to move from the current position is referred to as ‘position movement information’. The position determination device 422 may provide the position movement information to the position change device 43.

The position change device 43 may receive the position movement information. The position change device 43 may control the motor 30 so that the aerial relay moves to the target position based on the position movement information. Therefore, the aerial relay may be moved to the position based on the position movement information.

Although not illustrated in FIG. 7, when necessary, the position change device 43 may notify completion of the position movement to the position determination device 422 when the position movement is completed.

Steps S700 to S706 described above may be repeatedly performed N times as preconfigured. Here, N may be a natural number 2 or greater. The value of N may be preconfigured for the aerial relay by the base station through a higher layer message. By repeating steps S700 to S706 N times, the position determination device 422 may determine a position of the aerial relay having the highest signal quality between the aerial relay and the base station.

The case in which steps S700 to S706 described above are repeated N times has been described. This may correspond to a method in which the aerial relay finds an optimal position among a plurality of candidate positions. However, the aerial relay may also be configured to always determine an optimal position whenever it receives the pilot signal from the base station, without performing the N repetitions. Various modifications of such methods may also be implemented. Since it is not feasible to describe all modified examples in detail in the present disclosure, it should be noted that those skilled in the art will readily understand, based on the present disclosure, that modifications such as omitting a specific step or changing an order of steps fall within the scope of the present disclosure.

In addition, when the base station transmits the pilot signal, it may do so by taking into account a movement distance and movement time of the aerial relay. By transmitting the pilot signal while considering the movement distance and movement time of the aerial relay, the base station may allow the aerial relay to receive the pilot signal after moving from a first position to a next position. This may prevent unnecessary pilot transmissions. Through this, not only may power consumption of the base station be reduced, but interference that may be generated in the wireless environment may also be reduced.

In step S708, the position determination device 422 of the aerial relay may determine an optimal position based on signal quality measurement values for pilot signals received from the base station at N positions. The position determination device 422 may generate a report message including position information corresponding to the determined optimal position and may provide the report message to the transmitter 11.

In step S710, the transmitter 11 of the aerial relay may up-convert the report message including the determined position information into an RF band and may transmit the report message to the base station through antenna(s). When a specific beam is used for communication between the aerial relay and the base station, the transmitter 11 may transmit the report message through the specific beam. In step S710, the base station may receive the report message including the position information of the aerial relay.

In step S712, the base station may transmit a response message to the aerial relay to notify the aerial relay that the base station has received the position determination information of the aerial relay. Accordingly, in step S712, the aerial relay may receive the response message. When the receiver 12 of the aerial relay receives the response message from the base station, the receiver 12 may convert the received message into a baseband signal and may provide the baseband signal to the position determination device 422.

In step S714, the position determination device 422 may set the optimal position determined in step S708 as a final position and may provide position movement information to the position change device 43 to move to the final position. The position change device 43 may receive the position movement information and may control the motor 30 so that the aerial relay moves to the final position based on the position movement information.

When the signal quality value measured at the N-th position among the signal quality values of pilot signals received at the N positions is identified as the final position, step S714 may be omitted.

In step S716, the position determination device 422 may generate a report message including the final position information and may provide the report message to the transmitter 11. The transmitter 11 may up-convert the report message including the final position information to an RF band and may transmit the report message to the base station through antenna(s). In step S710, the base station may receive the report message including the final position information of the aerial relay from the aerial relay.

In step S718, the base station may transmit a response message to the aerial relay in order to inform the aerial relay that the base station receives the final position information of the aerial relay. Accordingly, in step S712, the aerial relay may receive the response signal. When the receiver 12 of the aerial relay receives the response signal from the base station, the receiver 12 may convert the received response signal into a baseband signal and may provide the baseband signal to the position determination device 422.

The aerial relay may operate as a relay node between the base station and a terminal based on reception of the response message for the final position information.

Meanwhile, in step S720, the base station may transmit the final position information of the aerial relay to a positioning server. In addition, the base station may receive a response signal from the positioning server.

In FIG. 7 described above, a time interval between the operation of determining the position of the aerial relay (step S708) and the operation of moving to the final position (step S714) may vary depending on a time required for transmission and reception between the aerial relay and the base station and the information processing time of each node.

As described in FIG. 7, when the aerial relay autonomously selects its position, control from a counterpart node (e.g. the base station or another aerial relay) is not required. Therefore, compared with a scheme in which the counterpart node selects the position of the aerial relay, the position of the aerial relay can be selected more quickly.

### B. Method in Which a Counterpart Node Determines a Position of an Aerial Relay

Hereinafter, an exemplary embodiment for a case in which a counterpart node determines a position of an aerial relay is described with reference to the accompanying drawings.

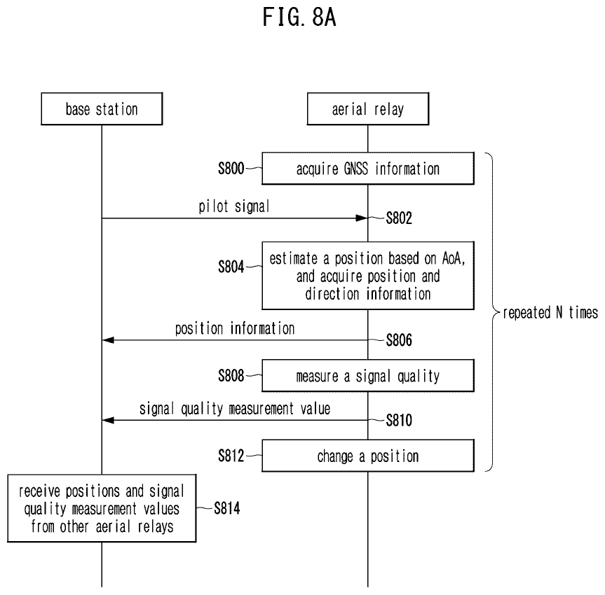

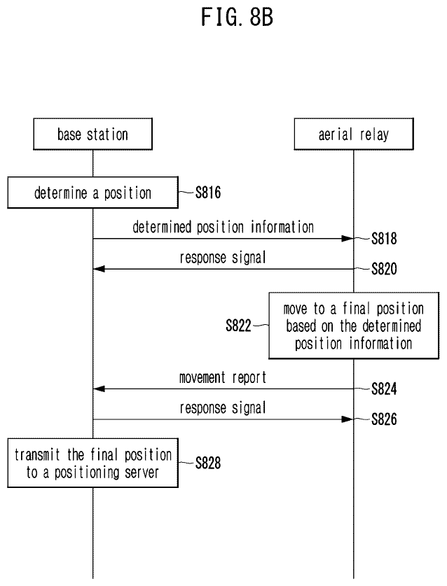

FIG. 8A is a portion of a sequence diagram illustrating a case in which a counterpart node determines a position of an aerial relay, and FIG. 8B is the remaining portion of the sequence diagram shown in FIG. 8A.

In step S800, the aerial relay may acquire GNSS information. The GNSS information may be acquired regardless of whether the aerial relay operates as a relay node as described above. Therefore, even when the aerial relay is in the sleep mode, the aerial relay may acquire GNSS information at a preset periodicity. The preset periodicity may be determined based on one or more pieces of information among a remaining battery capacity of the aerial relay, mobility of the aerial relay, or a range between a minimum periodicity and a maximum periodicity preset by the base station. When the aerial relay is in the active mode, the aerial relay may also acquire GNSS information at a preset periodicity. In this case, the preset periodicity may be determined based on the information described above.

As described above in the first exemplary embodiment, when the base station configures a minimum periodicity and/or a maximum periodicity at which the aerial relay needs to acquire GNSS information, the minimum periodicity and/or the maximum periodicity at which GNSS information needs to be acquired may be transmitted in advance by the base station to the aerial relay through a higher layer message (e.g. an RRC message or a MAC-CE message) between the base station and the aerial relay.

In step S800, the GNSS information may be acquired by the sensor information acquisition device 411 based on signals received from satellites through the sensor 20. The sensor information acquisition device 411 may provide the acquired GNSS information to the position acquisition device 414. If the sensor 20 further includes an inertial measurement device combining a magnetometer, an accelerometer, and/or a gyroscope, direction information of the aerial relay may further be provided to the position acquisition device 414. The position acquisition device 414 may calculate (or estimate) a position of the aerial relay using the GNSS information and/or the direction information of the aerial relay.

In step S802, the base station may transmit a specific signal (e.g. pilot signal) to the aerial relay at a preset periodicity or based on information configured between the base station and the aerial relay. Accordingly, in step S802, the receiver 12 of the aerial relay may receive the pilot signal from the base station. The receiver 12 may convert the received pilot signal into a baseband signal and may provide the baseband signal to the position acquisition device 414 and the signal quality measurement device 412.

In step S804, the position acquisition device 414 of the aerial relay may receive the pilot signal converted into the baseband signal from the receiver 12, and may estimate the position of the aerial relay by using phase differences between the pilot signals incident on respective antennas of the communication device. The position acquisition device 414 may identify a more accurate position of the aerial relay based on the GNSS information and the direction information acquired in step S800 and the position information estimated in step S804. The position acquisition device 414 may deliver a first report message including position information of the aerial relay to the transmitter 11. The first report message generated in step S804 may be reported at a time preconfigured for the aerial relay through a higher layer message (e.g. an RRC message and/or a MAC-CE message) between the base station and the aerial relay before step S800. Therefore, the position acquisition device 414 may deliver the first report message to the transmitter 11 before the preconfigured time so that the first report message can be transmitted at the preconfigured time.

In step S806, the transmitter 11 may up-convert the first report message received from the position acquisition device 414 to an RF band and may transmit the first report message to the base station through antenna(s). In this case, the first report message may be transmitted through a resource preconfigured for the aerial relay through a higher layer message (e.g. an RRC message and/or a MAC-CE message) between the base station and the aerial relay before step S800.

In step S808, the signal quality measurement device 412 may receive, from the receiver 12, the pilot signal that was received and converted into the baseband signal in step S802. The signal quality measurement device 412 may measure a signal quality of the received pilot signal. The signal quality measurement device 412 may generate a second report message including the measured signal quality measurement value.

The signal quality measurement device 412 may deliver the second report message including the signal quality measurement value measured for the pilot signal to the transmitter 11. The second report message generated in step S808 may be reported at a time preconfigured for the aerial relay through a higher layer message (e.g. an RRC message and/or a MAC-CE message) between the base station and the aerial relay before step S800. Therefore, the signal quality measurement device 412 may deliver the second report message to the transmitter 11 before the preconfigured time so that the second report message can be transmitted at the preconfigured time.

In step S810, the transmitter 11 may up-convert the second report message received from the signal quality measurement device 412 to an RF band and transmit the second report message to the base station through antenna(s). In this case, the second report message may be transmitted through a resource preconfigured for the aerial relay through a higher-layer message (e.g. an RRC message and/or a MAC-CE message) between the base station and the aerial relay before step S800.

Meanwhile, the first report message transmitted by the aerial relay in step S806 and the second report message transmitted by the aerial relay in step S810 may be transmitted once by being integrated into one message. In other words, before step S800, the base station may configure, through a higher layer message, such that the position information and signal quality measurement values are reported through a single message by the aerial relay. If it is configured by the higher layer message that the position information and signal quality measurement values of the aerial relay are simultaneously reported, step S810 may be performed simultaneously with step S806, may be performed before step S806, or may be performed before step S808.

When the first report message and the second report message are transmitted as one message as described above, there may be an advantage in that link congestion between the base station and the aerial relay can be reduced.

Referring again to FIG. 8A, after the aerial relay transmits the second report message including the signal quality measurement values in step S810, the next position of the aerial relay that performs the signal quality measurement may be determined in step S812. In other words, in step S812, the position determination device 424 may determine the position to which the aerial relay is to move. The position determination device 424 may generate position movement information based on the position determination of the aerial relay. The position determination device 424 may provide the generated position movement information to the position change device 43. The position movement information may include, for example, a position change command and direction information. In another example, the position movement information may include information on current coordinates and information on coordinates to which the aerial relay is to move.

The position change device 43 may control the motor 30 based on the position movement information. In other words, the position change device 43 may control the motor and move the aerial relay to a desired position.

Steps S800 to S812 may be repeatedly performed N times. Here, N may be a natural number equal to or greater than 2. By repeatedly performing steps S800 to S812 N times, the aerial relay may provide the base station with N signal quality measurement values and the corresponding positions of the aerial relay.

In step S814, the base station may acquire the positions and signal quality measurement values from other aerial relays.

Although FIG. 8A illustrates, for convenience of description and understanding, the procedure in which the base station acquires positions and signal quality measurement values from other aerial relays as a single step (step S814), this is merely a simplified example. In practice, in step S814, the procedure in which the base station acquires the position and signal quality measurement value from each of other aerial relays may be performed through steps S800 to S812. In addition, when three or more aerial relays exist within coverage of the base station, step S814 of receiving the positions and signal quality measurement values of aerial relays from the aerial relays may be repeatedly performed ‘a total number of aerial relays−1’ times. In other words, the base station may receive the position and the signal quality measurement value from each of the plural aerial relays.

The description above has been provided assuming that steps S800 to S812 are repeatedly performed N times. It has also been assumed that step S814 is repeatedly performed multiple times. However, after the base station performs steps S800 to S814, the base station may directly perform the steps of FIG. 8B described below.

There may be various modifications of these methods. Since it is not feasible to describe all such modifications one by one in the present disclosure, those skilled in the art should recognize that modifications such as omitting a particular step or changing the order of specific steps, to the extent understood based on the descriptions herein, all fall within the scope of the present disclosure.

Subsequent operations are described with reference to FIG. 8B. Accordingly, FIG. 8B may illustrate a sequence of operations following those in FIG. 8A.

In step S816, the base station may determine the position of each aerial relay using the positions and signal quality information of the aerial relays. This is described in more detail below.

The base station may receive N positions and N signal quality measurement values from a single aerial relay. In other words, each aerial relay may transmit its positions and signal quality measurement values to the base station through N repetitions. Accordingly, the base station may be in a state of having received N position values and N signal quality values from each of the aerial relays. Therefore, when determining the position of each aerial relay, the base station may select, as the position of the corresponding aerial relay, the position associated with the best signal quality.

In step S818, the base station may transmit the determined position information to each of the plurality of aerial relays. Since FIG. 8B illustrates a sequence diagram between the base station and a single aerial relay, it should be noted that only one instance of transmitting the determined position information from the base station to the aerial relay is illustrated.

In step S818, the receiver 12 of the aerial relay may receive the determined position information from the base station. The receiver 12 may convert the signal received from the base station into a baseband signal and provide the baseband signal to the position acquisition device 414. The position acquisition device 414 may identify the determined position information received from the base station. In addition, the position acquisition device 414 may generate a response signal corresponding to the determined position information and may provide the response signal to the transmitter 11.

In addition, the position acquisition device 414 may generate position movement information indicating whether the aerial relay needs to move, based on the determined position information, the GNSS information acquired in step S800 of the N-th repetition, and the position estimated in step S804 of the N-th repetition. The position acquisition device 414 may then provide the position movement information to the position change device 43.

If the N-th position is the same as the determined position received from the base station, the position acquisition device 414 may not generate the position movement information. Therefore, in this case, the position acquisition device 414 may not provide the position movement information to the position change device 43. When the position acquisition device 414 does not provide the position movement information to the position change device 43, step S822 illustrated in FIG. 8B may be omitted. In addition, in step S824, a movement report may be transmitted together with the response signal in step S820.

In step S820, the aerial relay may up-convert the response signal received from the position acquisition device 414 to an RF band and transmit the response signal to the base station through antenna(s). Accordingly, the base station may receive the response signal from the aerial relay in step S820.

In step S822, the position change device 43 of the aerial relay may control the motor 30 such that the aerial relay is moved to the position based on the position movement information. Therefore, the aerial relay may be moved to the position based on the position movement information.

In step S824, after the position change device 43 controls the motor to move the aerial relay to the position, the position change device 43 may generate a third report message including movement report information and deliver the third report message to the transmitter 11. Accordingly, the transmitter 11 may up-convert the third report message including the movement report information to an RF band and transmit the third report message to the base station through antenna(s).

In step S824, the base station may receive the third report message including the movement report information from the aerial relay.

In step S826, the base station may transmit a response message to the aerial relay in response to the reception of the third report message. Therefore, the receiver 12 of the aerial relay may receive the response message from the base station. The receiver 12 may convert the received response message into a baseband signal and deliver the baseband signal to the operation decision device 421. Therefore, the operation decision device 421 may cause the aerial relay to operate as a relay node.

Meanwhile, in step S828, the base station may transmit the final position of each of the aerial relays to a positioning server. The base station may also receive a response signal from the positioning server.

Comparing the method of selecting the position of the aerial relay according to FIGS. 8A and 8B with the method of FIG. 7 described above, the method of FIGS. 8A and 8B may provide the following advantages. Since this method allows a plurality of aerial relays distributed in the network to be deployed at appropriate positions from the perspective of the entire network, utilization of network resources can be increased. In addition, by deploying the aerial relays according to the conditions of the network, network congestion can be appropriately controlled. Furthermore, by enabling the base station to maintain appropriate intervals between the aerial relays, a situation in which the aerial relays become concentrated in a specific region can be prevented.

Meanwhile, in the second exemplary embodiment described with reference to FIG. 7, FIG. 8A, and FIG. 8B, the aerial relay may identify its position by using position information acquired from GNSS information measured through a built-in sensor, position information obtained from AoAs estimated based on received pilot signals, or position information estimated using TDoA. In addition, when GNSS information measured through the built-in sensor is used, the aerial relay may compensate for GNSS uncertainty caused by jitter by receiving pilot signals according to a network instruction and additionally using position information estimated based on the AoAs of the received pilot signals.

### Third Exemplary Embodiment: Method in Which an Aerial Relay Tracks a Position of a Counterpart Node and Supports the Counterpart Node

The third exemplary embodiment of the present disclosure describes a method in which an aerial relay tracks a position of a counterpart node and supports the counterpart node. According to the third exemplary embodiment, the aerial relay may track a position of a moving counterpart node and support the counterpart node through periodic signaling with the counterpart node. Here, the counterpart node may include another aerial relay connected through a communication link with the aerial relay, a user terminal, or the like.

A method of tracking and supporting the position of a counterpart node may also be classified into a case in which the aerial relay determines its own operation and a case in which the counterpart node determines the operation of the aerial relay, depending on which entity makes the operational decision.

### A. Method in Which an Aerial Relay Autonomously Determines Position Tracking of a Counterpart Node and Whether to Operate as a Relay Node

Hereinafter, exemplary embodiments for a case in which the aerial relay autonomously determines whether to perform position tracking of a counterpart node are described with reference to the accompanying drawings.

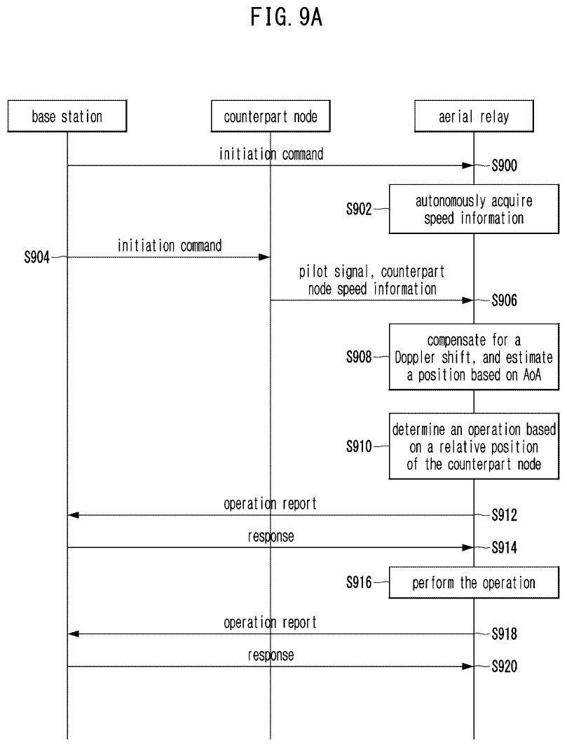

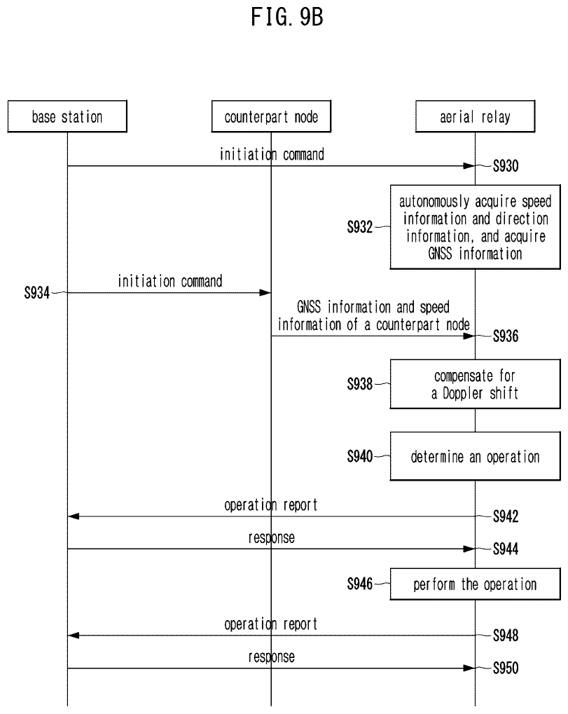

FIG. 9A is a sequence diagram illustrating a first exemplary embodiment for a case where an aerial relay autonomously determines whether to move while tracking a position of a counterpart node.

The exemplary embodiment of FIG. 9A corresponds to a case in which an aerial relay needs to autonomously determine whether it is to operate as a relay node while tracking the position of a counterpart node. This requirement may be determined by the base station. In other words, the base station may previously recognize that the aerial relay needs to autonomously determine whether to operate as a relay node while tracking the position of the counterpart node.

In step S900, the base station may generate a first message including an initiation command for instructing the aerial relay to autonomously perform position tracking of the counterpart node and determination on whether to operate as a relay node. The base station may transmit the first message to the aerial relay. The first message may further include identification information of the counterpart node. The first message may further include information (e.g. indicator of one bit or two or more bits) indicating a position tracking scheme for the counterpart node. The position tracking scheme for the counterpart node may include, for example, one of a scheme of using a pilot signal received from the counterpart node and a scheme of using GNSS information received from the counterpart node. In the exemplary embodiment of FIG. 9A, a case is assumed in which information indicating the scheme of using the pilot signal received from the counterpart node is included in the first message.

In step S900, the aerial relay may receive the initiation command from the base station. More specifically, the receiver 12 of the aerial relay may convert the initiation command received from the base station into a baseband signal and deliver the baseband signal to the sensor information acquisition device 411.

In step S902, the sensor information acquisition device 411 of the aerial relay may acquire speed information of the aerial relay in response to the received initiation command. The speed information of the aerial relay may be determined based on information acquired from the sensor 20. More specifically, the sensor information acquisition device 411 may acquire the speed information of the aerial relay based on information received from the inertial measurement device included in the sensor 20.

In this case, since the position tracking scheme for the counterpart node included in the first message received from the base station indicates the case in which the aerial relay is instructed to receive the pilot signal from the counterpart node, the sensor information acquisition device 411 may control the sensor 20 to receive only the speed information of the aerial relay.

In another example, the sensor information acquisition device 411 may calculate (or acquire) the speed of the aerial relay using both the GNSS information and the information received from the inertial measurement device or using only the GNSS information irrespective of the position tracking scheme for the counterpart node indicated by the first message.

In a method of calculating the speed of the aerial relay using only GNSS information, GNSS information acquired at two or more different times may be used. The sensor information acquisition device 411 may provide the calculated speed information of the aerial relay to the position acquisition device 414.

Meanwhile, in step S904, the base station may transmit a second message to the counterpart node. The second message may include an initiation command instructing the counterpart node to transmit position-related information of the counterpart node to the aerial relay. The second message may further include identification information of the aerial relay, information to be provided to the aerial relay, and information on a resource to be used for transmission to the aerial relay based on the second message. The information that the counterpart node needs to transmit to the aerial relay may include, for example, speed information of the counterpart node. The information may further include an instruction for transmitting a pilot signal to the aerial relay. If necessary, the second message may also indicate a format of the pilot signal. Accordingly, the counterpart node may receive the second message including the initiation command from the base station.

In step S906, the counterpart node may transmit the pilot signal and the speed information of the counterpart node to the aerial relay in response to receiving the second message. When the pilot signal transmitted by the counterpart node is configured as a sequence such as a synchronization signal, the pilot signal and the speed information may be transmitted as separate messages. In FIG. 9A, this is illustrated as a single step for simplicity.

In step S906, the aerial relay may receive the pilot signal from the counterpart node and may also receive a message including the speed information of the counterpart node. The communication link between the aerial relay and the counterpart node may use an uplink (UL) of a mobile communication system or another type of communication link (e.g. a relay link or a newly defined link). When a mobile communication system is used, a pre-defined uplink resource between the aerial relay and the counterpart node, or a resource configured by the base station, may be used.

The receiver 12 of the aerial relay may convert the pilot signal received from the counterpart node into a baseband signal and may also convert the message including the speed information of the counterpart node into a baseband signal. The pilot signal and the speed information, after being converted into baseband signals, may be delivered from the receiver 12 to the position acquisition device 414.

In step S908, the position acquisition device 414 may acquire Doppler shift information based on the pilot signals received from the counterpart node, the speed information received from the counterpart node, and the speed of the aerial relay obtained from the position acquisition device 414, and may compensate for the Doppler shift of the pilot signal using the Doppler shift information. The position acquisition device 414 may estimate the position of the counterpart node based on AoAs of the pilot signals received from the counterpart node. The position acquisition device 414 may then provide information on the estimated position of the counterpart node to the operation decision device 423.

In step S910, the operation decision device 423 may determine whether the aerial relay is to move based on the counterpart node position information delivered from the position acquisition device 414. The exemplary embodiment of FIG. 9A may correspond to a procedure in which the aerial relay is determined to operate as a relay node for the counterpart node. If the aerial relay is determined not to operate as a relay node for the counterpart node, the operations of steps S916 to S920 described below may not be performed.

The operation decision device 423 may generate a third message including operation report information indicating whether the aerial relay is to move based on the position of the counterpart node. The movement of the aerial relay may refer, for example, to movement by a specific distance (e.g. 3 meters or 5 meters) in the direction in which the counterpart node is moving, based on the speed of the counterpart node. The operation decision device 423 may deliver the third message including the operation information regarding the movement of the aerial relay to the transmitter 11.

In step S912, the transmitter 11 may up-convert the third message to an RF band and transmit the third message to the base station. Accordingly, the base station may receive the third message including the operation report information related to the movement of the aerial relay. The base station may identify the movement information of the aerial relay based on the third message.

In step S914, the base station may transmit a response message acknowledging the reception of the third message to the aerial relay. Accordingly, in step S914, the aerial relay may receive the response message. The receiver 12 of the aerial relay may convert the received response message into a baseband signal and provide the baseband signal to the operation decision device 423.

In step S916, the operation decision device 423 may provide an operation command to the position change device 43 based on the reception of the response signal. The operation command may include information indicating a position at which the aerial relay is to be located, based on the position, movement speed, and movement direction of the aerial relay and the position, movement speed, and movement direction of the counterpart node.

In another example, the position change device 43 may periodically acquire position information of the aerial relay from the position acquisition device 414 and the sensor information acquisition device 412, and may identify the position information of the counterpart node.

The position change device 43 may generate a control signal to control the motor 30 such that the position of the aerial relay is adjusted based on the positions of the aerial relay and the counterpart node, and may drive the motor 30 accordingly. Through this procedure, the aerial relay may operate as a relay node while tracking the counterpart node.

In addition, the position change device 43 may generate a fourth message including operation report information while controlling the motor 30 so that the aerial relay tracks the counterpart node, either simultaneously with the tracking operation or prior to the tracking operation. The operation report information may include state information indicating that the aerial relay operates as a relay node by tracking the position of a specific counterpart node. Accordingly, the operation report information may include identification information of the counterpart node. The operation report information may further include operation state information such as the position and/or trajectory of the aerial relay and the position and/or trajectory of the counterpart node. The position change device 43 may provide the fourth message to the transmitter 11.

A time difference between the time at which the aerial relay determines to operate as a relay node while tracking the position of a specific counterpart node in step S910 and the time at which the aerial relay actually begins operating as a relay node while tracking the position of that counterpart node in step S916 may depend on a distance between the aerial relay and the base station and an information processing time of the aerial relay and the base station.

In step S918, the transmitter 11 may up-convert the fourth message received from the position change device 43 to an RF band and transmit the fourth message to the base station. Accordingly, the base station may receive the fourth message including the operation report information from the aerial relay. Based on the fourth message, the base station may identify that the aerial relay is operating as a relay node for the specific counterpart node.

In step S920, the base station may transmit a response message acknowledging the reception of the fourth message to the aerial relay. Accordingly, the aerial relay may receive the response message from the base station. More specifically, the receiver 12 of the aerial relay may convert the response message received from the base station into a baseband signal and provide the baseband signal to the position change device 43 and/or the operation decision device 423.

FIG. 9B is a sequence diagram illustrating a second exemplary embodiment for a case where an aerial relay autonomously determines whether to move while tracking a position of a counterpart node.

The exemplary embodiment of FIG. 9B may also correspond to a case in which the aerial relay autonomously determines whether it needs to operate as a relay node while tracking the position of a counterpart node, as described above with reference to FIG. 9A. This requirement may be determined by the base station, as in the exemplary embodiment of FIG. 9A. In other words, the base station may already recognize that the aerial relay needs to autonomously determine whether to operate as a relay node while tracking the position of the counterpart node. In step S930, the base station may generate a first message including an initiation command instructing the aerial relay to autonomously determine whether it is to operate as a relay node and to perform position tracking of the counterpart node, and may transmit the first message to the aerial relay. The first message may further include identification information of the counterpart node. In addition, the first message may include information indicating a position tracking scheme for the counterpart node (e.g. an indicator of one bit or two or more bits). As described above with reference to FIG. 9A, the position tracking scheme for the counterpart node may be one of a scheme using a pilot signal received from the counterpart node or a scheme using GNSS information received from the counterpart node. In the exemplary embodiment of FIG. 9A, a case is assumed in which the first message includes information instructing the aerial relay to receive GNSS information from the counterpart node.

In step S930, the aerial relay may receive the initiation command from the base station. More specifically, the receiver 12 of the aerial relay may convert the initiation command received from the base station into a baseband signal and provide the baseband signal to the sensor information acquisition device 411.

In step S932, the sensor information acquisition device 411 of the aerial relay may receive GNSS information of the aerial relay from the sensor 20 based on the received initiation command.

In addition, in step S932, the sensor information acquisition device 411 may acquire speed information and direction information of the aerial relay based on information obtained from the sensor 20 (e.g. information received from the inertial measurement device described above). The speed information and direction information of the aerial relay may also be acquired using GNSS information of the aerial relay obtained at predetermined time intervals. The sensor information acquisition device 411 may provide the acquired GNSS information, the speed information of the aerial relay, and the direction information to the operation decision device 423. The GNSS information acquired by the sensor information acquisition device 411, together with the speed information and the direction information of the aerial relay, may be used to determine a direction and movement toward the counterpart node based on the position and movement direction of the aerial relay.

Meanwhile, in step S934, the base station may transmit a second message to the counterpart node. The second message may include an initiation command instructing the counterpart node to transmit position-related information of the counterpart node to the aerial relay. In addition, the second message may include identification information of the aerial relay, information to be delivered to the aerial relay, and resource information to be used for transmitting the information to the aerial relay based on the second message. The information that the counterpart node needs to transmit to the aerial relay may include, for example, GNSS information of the counterpart node and speed information of the counterpart node. Accordingly, the counterpart node may receive the second message including the initiation command from the base station.

In step S936, the counterpart node may transmit GNSS information of the counterpart node and speed information of the counterpart node to the aerial relay in response to reception of the second message. Accordingly, the aerial relay may receive a message including the GNSS information and the speed information of the counterpart node from the counterpart node. More specifically, the receiver 12 of the aerial relay may convert the GNSS information and the speed information of the counterpart node received from the counterpart node into a baseband signal and provide the baseband signal to the operation decision device 423.

Here, as a communication link between the aerial relay and the counterpart node, an uplink of a mobile communication system may be used, or a separately defined communication link may be employed. When an uplink of the mobile communication system is used, a predefined resource or a resource configured by the base station may be used between the aerial relay and the counterpart node.

In step S938, the operation decision device 423 may compensate for a Doppler shift of a signal received from the counterpart node based on the speed information of the counterpart node received from the counterpart node and the speed information of the aerial relay.

In step S940, the operation decision device 423 may determine whether the aerial relay tracks the position of the counterpart node and operates as a relay node based on the GNSS information of the aerial relay received from the position acquisition device 414, the movement speed of the aerial relay, the GNSS information of the counterpart node received from the counterpart node, and the movement speed of the counterpart node. In a more specific exemplary embodiment, the operation decision device 423 may determine whether the aerial relay operates as a relay node of the counterpart node through two or more stages.

For example, the operation decision device 423 may determine whether the aerial relay operates as a relay node while tracking the position of the counterpart node by comparing the position of the aerial relay with the position of the counterpart node. If a distance between the position of the aerial relay and the position of the counterpart node is within a preset threshold distance, the operation decision device 423 may determine that the aerial relay operates as a relay node while tracking the position of the counterpart node. In contrast, if the distance between the two positions exceeds the preset threshold distance, the operation decision device 423 may determine that the aerial relay does not operate as a relay node.

When the operation decision device 423 determines, based on the distance between the aerial relay and the counterpart node, that the aerial relay operates as a relay node while tracking the position of the counterpart node, the operation decision device 423 may further perform a second-stage determination based on the speed of the aerial relay and the speed of the counterpart node. If the speed of the counterpart node is greater than or equal to a threshold value, or if the speed of the counterpart node exceeds the speed of the aerial relay, the operation decision device 423 may determine that the aerial relay does not operate as a relay node. In contrast, if the speed of the counterpart node is less than the threshold value and is slower than the speed of the aerial relay, the operation decision device 423 may determine that the aerial relay operates as a relay node while tracking the position of the counterpart node.

Finally, in a third step, the operation decision device 423 may determine whether the aerial relay operates as a relay node while tracking the position of the counterpart node based on the movement direction of the aerial relay and the movement direction of the counterpart node.

The three steps described above are merely an exemplary embodiment provided to facilitate understanding of the present disclosure and should not be construed as limiting. In addition, the three steps may be performed in an order different from the order described above.

The exemplary embodiment of FIG. 9B may correspond to a case in which the aerial relay is determined to operate as a relay node of the counterpart node. If the aerial relay is determined not to operate as a relay node for the counterpart node, the operations of steps S946 to S950 described below may not be performed.

The operation decision device 423 may generate a third message including operation report information indicating whether the aerial relay operates as a relay node for the counterpart node. The operation decision device 423 may provide the third message to the transmitter 11.

In step S942, the transmitter 11 may up-convert the third message to an RF band and transmit the third message to the base station. Accordingly, the base station may receive the third message including operation report information on whether the aerial relay operates as a relay node for the counterpart node from the aerial relay. The base station may determine whether the aerial relay operates as a relay node based on the third message.

In step S944, the base station may transmit a response message responding to the reception of the third message to the aerial relay. Accordingly, in step S944, the aerial relay may receive the response message. The receiver 12 of the aerial relay may convert the received response message into a baseband signal and provide the baseband signal to the operation decision device 423.

In step S946, the operation decision device 423 may provide an operation command to the position change device 43 based on the reception of the response signal. The operation command may include information indicating a position at which the aerial relay needs to be located, based on the position of the aerial relay, the movement speed of the aerial relay, the movement direction of the aerial relay, the position of the counterpart node, the movement speed of the counterpart node, and the movement direction of the counterpart node.

In another example, the position change device 43 may periodically acquire position information of the aerial relay from the position acquisition device 414 and the sensor information acquisition device 412, and may identify position information of the counterpart node.

The position change device 43 may generate a control signal for controlling the motor 30 so that the position of the aerial relay is changed based on the position of the aerial relay and the position of the counterpart node, and may drive the motor 30 accordingly. Through such a procedure, the aerial relay may operate as a relay node while tracking the counterpart node.

In addition, the position change device 43 may generate a fourth message including operation report information while driving the motor 30 so that the aerial relay tracks the counterpart node, either simultaneously with or prior to the tracking operation. The operation report information may include state information indicating that the aerial relay operates as a relay node by tracking the position of a specific counterpart node. Accordingly, the operation report information may include identification information of the counterpart node. In addition, the operation report information may further include operation state information such as position information and/or route information of the aerial relay, and position information and/or route information of the counterpart node. The position change device 43 may provide the fourth message to the transmitter 11.

Meanwhile, a time difference between the time at which the aerial relay decides to operate as a relay node while tracking the position of a specific counterpart node in step S940 and the time at which the aerial relay actually operates as a relay node while tracking the position of the specific counterpart node in step S946 may be determined according to a distance between the aerial relay and the base station and an information processing time in each of the aerial relay and the base station.

In step S948, the transmitter 11 may up-convert the fourth message received from the position change device 43 to an RF band and transmit the fourth message to the base station. Accordingly, the base station may receive the fourth message including operation report information from the aerial relay. The base station may identify that the aerial relay operates as a relay node with respect to the specific counterpart node based on the fourth message.

In step S950, the base station may transmit a response message responding to reception of the fourth message to the aerial relay. Accordingly, the aerial relay may receive the response message from the base station. More specifically, the receiver 12 of the aerial relay may convert the response message received from the base station into a baseband signal and provide the baseband signal to the position change device 43 and/or the operation decision device 423.

In the third exemplary embodiment described above, a case in which position, speed, and direction information of the counterpart node are received directly from the counterpart node has been assumed. However, the counterpart node may measure, receive, or infer its own position, speed, and direction information in the network and may transmit the information to the aerial relay. In such a modified case, the third exemplary embodiment has an advantage in that the procedure can be performed without establishing a new communication link between the aerial relay and the counterpart node.

As described above with reference to FIG. 9A and FIG. 9B, when the aerial relay autonomously determines whether it performs position tracking of the counterpart node and operates as a relay node, the determination may be made more rapidly compared to a case in which the determination is made by the network or another relay node.

### B. Method in Which a Network Determines Position Tracking of a Counterpart Node and Whether an Aerial Relay is to Operate as a Relay Node

In exemplary embodiments below, a network is assumed to be a base station, and exemplary embodiments in which it is determined by the base station whether an aerial relay performs position tracking of a counterpart node are described with reference to the accompanying drawings.

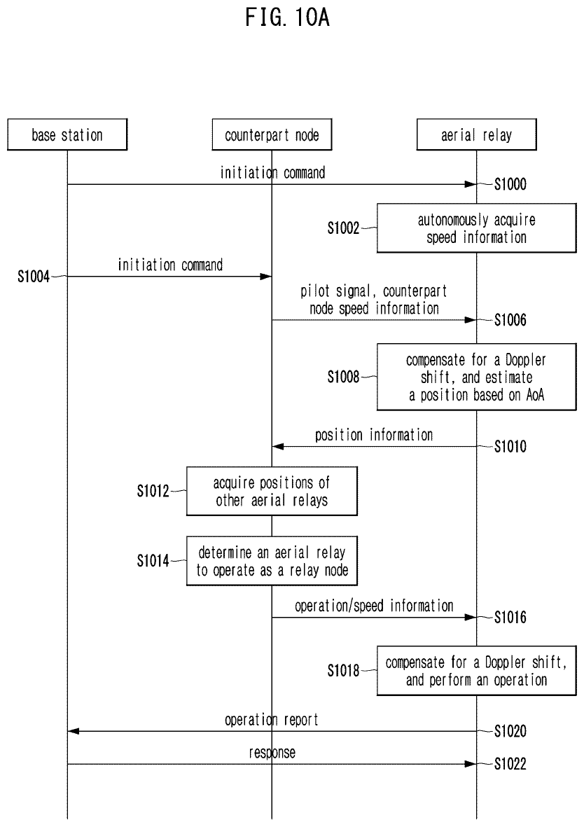

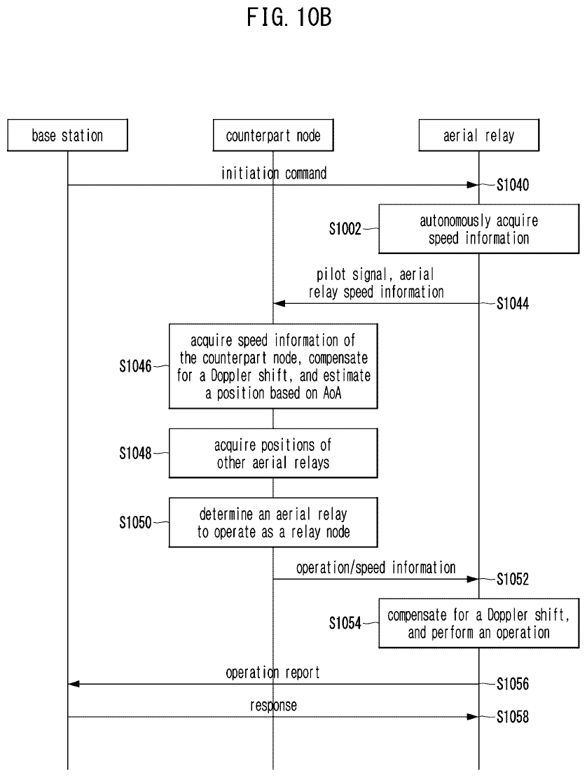

FIG. 10A is a sequence diagram illustrating a first exemplary embodiment for a case where a counterpart node determines whether an aerial relay moves while tracking a position of the counterpart node.

The exemplary embodiment of FIG. 10A may correspond to a case in which a counterpart node determines whether an aerial relay operates as a relay node while tracking the position of the counterpart node. The base station may already know this information in advance or may determine it.

In step S1000, the base station may generate a first message including an initiation command instructing the counterpart node to determine whether an aerial relay operates as a relay node while tracking the position of the counterpart node. The base station may transmit the first message to the aerial relay. The first message may further include identification information of the counterpart node. In addition, the first message may include information indicating a position tracking scheme for the counterpart node (e.g. an indicator of one bit or two or more bits). The position tracking scheme for the counterpart node may specify one of the following: a scheme using pilot signals received from the counterpart node, or a scheme using GNSS information received from the counterpart node. In the exemplary embodiment of FIG. 10A, it is assumed that the first message includes information indicating the scheme using pilot signals received from the counterpart node.

In step S1000, the aerial relay may receive the initiation command from the base station. More specifically, the receiver 12 of the aerial relay may convert the initiation command received from the base station into a baseband signal and provide the baseband signal to the sensor information acquisition device 411.

In step S1002, the sensor information acquisition device 411 of the aerial relay may acquire speed information of the aerial relay in response to the received initiation command. The speed information of the aerial relay may be determined based on information acquired from the sensor 20. More specifically, the sensor information acquisition device 411 may acquire the speed information of the aerial relay based on information received from the inertial measurement device included in the sensor 20.

In this case, since the position tracking scheme for the counterpart node included in the first message received from the base station corresponds to the scheme of using pilot signals received from the counterpart node, the sensor information acquisition device 411 may control reception such that only speed information of the aerial relay is received from the sensor 20. In another example, the sensor information acquisition device 411 may calculate (or acquire) the speed of the aerial relay using both GNSS information and information received from the inertial measurement device or using only GNSS information, regardless of the position tracking scheme for the counterpart node indicated by the first message.

The method of calculating the speed of the aerial relay using only GNSS information may use GNSS signals received at two or more different times. The sensor information acquisition device 411 may provide the acquired speed information of the aerial relay to the position acquisition device 411.

Meanwhile, in step S1004, the base station may transmit a second message to the counterpart node. The second message may include an initiation command instructing the counterpart node to transmit counterpart node position-related information to the aerial relay. In addition, the second message may further include identification information of the aerial relay, information to be provided to the aerial relay, and resource information used for transmission of the second message. The information that the counterpart node needs to provide to the aerial relay may include, for example, speed information of the counterpart node. The information may further include an instruction to transmit pilot signals to the aerial relay. If necessary, the first message may also indicate a format of the pilot signal. Accordingly, the counterpart node may receive the second message including the initiation command from the base station.

In step S1006, the counterpart node may transmit pilot signals and speed information of the counterpart node to the aerial relay in response to receiving the second message. When the pilot signals transmitted by the counterpart node are configured as sequences such as a synchronization signal, the pilot signals and the speed information may be transmitted as separate messages. It should be noted that, in FIG. 10A, this transmission is illustrated as a single step for simplicity of the drawing.

In step S1006, the aerial relay may receive the pilot signals from the counterpart node and may also receive a message including the speed information of the counterpart node. As a communication link between the aerial relay and the counterpart node, an uplink of a mobile communication system or a separately defined communication link may be used. When an uplink of the mobile communication system is used, predefined resources or resources configured by the base station may be used between the aerial relay and the counterpart node.

The receiver 12 of the aerial relay may convert the pilot signals received from the counterpart node into baseband signals, and may also convert the message including the speed information of the counterpart node into a baseband signal. The pilot signals and the speed information, after conversion into baseband signals, may be provided to the position acquisition device 414 by the receiver 12.

In step S1008, the position acquisition device 414 may acquire Doppler shift information based on the pilot signals received from the counterpart node, the speed information received from the counterpart node, and the speed of the aerial relay acquired by the position acquisition device 414, and may compensate for Doppler shift of the pilot signals using the Doppler shift information. In addition, the position acquisition device 414 may estimate the position of the counterpart node based on AoAs of the pilot signals received from the counterpart node. The position acquisition device 414 may provide a third message including information on the estimated position of the counterpart node and the position of the aerial relay to the transmitter 11.

In step S1010, the transmitter 11 may up-convert the third message to an RF band for communication with the counterpart node and may transmit the third message to the counterpart node. When a link established between the counterpart node and the aerial relay has reciprocity, the third message may be transmitted using a beam formed in the direction in which the pilot signal was received from the counterpart node.

In step S1010, the counterpart node may receive the third message including the position information of the aerial relay and the estimated position of the counterpart node.

Meanwhile, in step S1012, the counterpart node may receive a message identical to the third message from another aerial relay. That is, when the counterpart node is located within coverage of the base station, the counterpart node may receive one or more messages identical to the third message from other aerial relays that received the initiation command from the base station. The third messages received from the other aerial relays may include position information of the respective aerial relays.

Although only one step S1012 is illustrated for brevity of the drawing and convenience of description, when there are two or more other aerial relays, third messages may be received respectively from each of the other aerial relays.

It should be noted that step S1012 is illustrated as a single step in FIG. 10A for convenience of description and brevity of the drawing. Hereinafter, the aerial relay illustrated in FIG. 10A is referred to as a first aerial relay, and when there are two other aerial relays, the respective aerial relays are referred to as a second aerial relay, a third aerial relay, and so on.

In step S1012, the counterpart node may determine a specific aerial relay to operate as a relay node based on the third message received from the first aerial relay, the third message received from the second aerial relay, and the third message received from the third aerial relay. A method by which the counterpart node determines the aerial relay to serve as the relay node may vary depending on the information included in the respective third messages.

When only the position information of each aerial relay is included in the third messages, the counterpart node may determine the aerial relay closest to the counterpart node as the relay node.

When the third messages include both the position information and the speed information of the aerial relays, the counterpart node may determine the relay node based on the speed and position information. For example, even if an aerial relay is the closest, the aerial relay may be excluded when its speed is significantly slower than the speed of the counterpart node (e.g. when a speed difference between the aerial relay and the counterpart node is greater than or equal to a first threshold value), or significantly faster than the speed of the counterpart node (e.g. when the speed difference is greater than or equal to a second threshold value).

When the third messages further include direction information of the aerial relays, an aerial relay whose movement direction is opposite to the movement direction of the counterpart node may also be excluded.

In step S1014, the counterpart node may determine the aerial relay to operate as the relay node based on the positions of the aerial relays using one or more of the methods described above.

In step S1016, the counterpart node may transmit a fourth message including the speed information of the counterpart node and information indicating determination as the relay node to the first aerial relay. In addition, the counterpart node may transmit fourth messages to the second aerial relay and the third aerial relay, the fourth messages including information indicating that the second aerial relay and the third aerial relay are not determined as relay nodes. Unlike the fourth message transmitted to the first aerial relay, the fourth messages transmitted to the second aerial relay and the third aerial relay may not include the speed information of the counterpart node. In FIG. 10A, only the first aerial relay, the counterpart node, and the base station are illustrated for simplicity of the drawing.

In step S1016, the first aerial relay may receive the fourth message including the speed information of the counterpart node and the information indicating determination as the relay node. More specifically, the receiver 12 of the first aerial relay may receive the fourth message, convert the received message into a baseband signal, and provide the baseband signal to the position change device 43.

The position change device 43 may identify the movement speed information of the counterpart node based on the received fourth message and may identify that the first aerial relay has been determined as the relay node. The position change device 43 may provide a speed request (or command) for the first aerial relay to the position acquisition device 414 in order to acquire the speed of the first aerial relay.

When the position acquisition device 414 receives the speed request for the first aerial relay, the position acquisition device 414 may acquire the speed information of the first aerial relay based on information received from the inertial measurement device included in the sensor 20. The position acquisition device 414 may then provide the acquired speed information of the first aerial relay to the position change device 43.

In step S1018, the position change device 43 may compensate for Doppler shift of a signal received from the counterpart node by using the speed information of the first aerial relay provided from the counterpart node and the sensor information acquisition device 414. In addition, the position change device 43 may configure the first aerial relay to operate as a relay node. In the exemplary embodiment of FIG. 10A, the first aerial relay operating as the relay node may control the motor 30 so that the first aerial relay moves in accordance with the speed of the counterpart node.

The position change device 43 may generate a report message for reporting an operation performed after configuring the first aerial relay to operate as the relay node. The position change device 43 may provide the report message to the transmitter 11.

In step S1020, the transmitter 11 may convert the operation performance report message into an RF band and may transmit the operation performance report message to the base station through the antenna. In this case, a link from the first aerial relay to the base station may be a relay link or may be an uplink of a mobile communication system. When the uplink of the mobile communication system is used, the uplink resource may be a resource preconfigured for the first aerial relay by the base station.

In step S1020, the base station may receive the operation performance report message from the first aerial relay. Through this, the base station may identify that the aerial relay operating as the relay node for the counterpart node is the first aerial relay.

In step S1022, the base station may generate a response message responding to reception of the operation performance report message and may transmit the response message to the first aerial relay. The first aerial relay may receive the response message.

Meanwhile, a time interval from when the first aerial relay transmits position information to the counterpart node until the first aerial relay operates as the relay node may vary depending on a transmission and reception time between the first aerial relay and the counterpart node and an information processing time of each node.

The first exemplary embodiment of the method in which the network determines position tracking of the counterpart node and whether the aerial relay is to operation as a relay node described above may correspond to a method using AoAs of pilot signals received from the counterpart node. In addition, the first exemplary embodiment may represent a case in which the counterpart node has a single antenna. However, it should be noted that the present disclosure is not limited to the case in which the counterpart node has only a single antenna.

FIG. 10B is a sequence diagram illustrating a second exemplary embodiment for a case where a counterpart node determines whether an aerial relay moves while tracking a position of the counterpart node.

The exemplary embodiment of FIG. 10B may correspond to a case in which the counterpart node needs to determine whether an aerial relay operates as a relay node while tracking the position of the counterpart node. The base station may previously know such information or may determine such information.

In step S1040, the base station may generate a first message including an initiation command instructing the counterpart node to determine whether an aerial relay operates as a relay node for the counterpart node while tracking the position of the counterpart node. The base station may transmit the first message to the aerial relay. The first message may further include identification information of the counterpart node. In addition, the first message may include information indicating a position tracking scheme for the counterpart node (e.g. an indicator of one bit or two or more bits). The position tracking scheme for the counterpart node may be one of a scheme in which the aerial relay transmits pilot signals to the counterpart node and a scheme in which the aerial relay transmits GNSS information to the counterpart node. In the exemplary embodiment of FIG. 10B, it is assumed that the first message includes information indicating the scheme in which the aerial relay transmits a pilot signal to the counterpart node.

In step S1040, the aerial relay may receive the initiation command from the base station. More specifically, the receiver 12 of the aerial relay may convert the initiation command received from the base station into a baseband signal and may provide the baseband signal to the sensor information acquisition device 411.

In step S1042, the sensor information acquisition device 411 of the aerial relay may acquire speed information of the aerial relay in response to the received initiation command. The speed information of the aerial relay may be determined based on information acquired from the sensor 20. More specifically, the sensor information acquisition device 411 may acquire the speed information of the aerial relay based on information received from the inertial measurement device included in the sensor 20.

In another example, the sensor information acquisition device 411 may calculate the speed of the aerial relay by using GNSS signals received from the sensor 20. The method of calculating the speed of the aerial relay by using the GNSS signals may use GNSS information received at two or more different times. The sensor information acquisition device 411 may provide the acquired speed information of the aerial relay to the position acquisition device 414.

When the position acquisition device 414 receives the speed information of the aerial relay from the sensor information acquisition device 411, the position acquisition device 414 may provide a pilot signal to the transmitter 11. In addition, the position acquisition device 414 may generate a second message including the speed information of the aerial relay and may transmit the second message to the transmitter 11.

In step S1044, the transmitter 11 may up-convert the pilot signal to an RF band and may transmit the pilot signal to the counterpart node. In addition, the transmitter 11 may up-convert the second message to the RF band and may transmit the second message to the counterpart node. As a communication link between the aerial relay and the counterpart node, a relay link, a downlink of a mobile communication system, or a communication link separately defined for communication between the relay node and the counterpart node may be used. When a downlink of a mobile communication system is used, information on resources to be used by the aerial relay for communication with the counterpart node may be further included in the initiation command transmitted by the base station.

In step S1044, the counterpart node may receive the pilot signal and the second message from the aerial relay.

In step S1046, the counterpart node may acquire speed information of the counterpart node in response to receiving the pilot signal and the second message from the aerial relay. When the counterpart node is a terminal of a mobile communication system (e.g. UE), various methods may exist for acquiring the speed of the counterpart node according to specifications of the terminal. The present disclosure does not impose any particular restriction on the method by which the counterpart node acquires its speed. In other words, any known method or any new method proposed in the future may be used.

The counterpart node may compensate for Doppler shift of the pilot signal received from the aerial relay in step S1044 by using the acquired speed information of the counterpart node. Redundant description is omitted here since Doppler shift compensation has been explained above. In addition, the counterpart node may estimate the position of the aerial relay based on AoAs of the pilot signals received from the aerial relay in step S1044.

Meanwhile, in step S1048, the counterpart node may receive one or more messages identical to the second message from other aerial relays. That is, when the counterpart node is located within coverage of the base station, the counterpart node may receive second messages from one or more other aerial relays that have received the initiation command from the base station. The second messages received from the other aerial relays may include speed information of the respective aerial relays.

In addition, the counterpart node may receive pilot signals from the other aerial relays before receiving the corresponding second messages. Therefore, the counterpart node may acquire position information of the other aerial relays.

Although step S1012 is illustrated only once in FIG. 10A for brevity of the drawing and convenience of description, when two or more other aerial relays exist, third messages may be received respectively from the other aerial relays.

It should be noted that step S1048 is illustrated as a single step in FIG. 10B for convenience of description and brevity of the drawing. Hereinafter, the aerial relay illustrated in FIG. 10B is referred to as a first aerial relay, and when there are two other aerial relays, the respective aerial relays are referred to as a second aerial relay, a third aerial relay, and so on.

In step S1050, the counterpart node may determine a specific aerial relay as a relay node based on an estimated position of the first aerial relay acquired from the pilot signal received from the first aerial relay, an estimated position of the second aerial relay acquired from the pilot signal received from the second aerial relay, an estimated position of the third aerial relay acquired from the pilot signal received from the third aerial relay, and speed information of the respective aerial relays. As a simplest method, an aerial relay whose estimated position is closest to the counterpart node may be selected. However, the speeds described in the exemplary embodiments above may be further considered as an exclusion condition.

In step S1052, the counterpart node may transmit a third message including speed information of the counterpart node and information indicating that the first aerial relay is determined as a relay node. In addition, the counterpart node may transmit third messages to the second aerial relay and the third aerial relay, the third messages including information indicating that the second aerial relay and the third aerial relay are not determined as relay nodes.

Unlike the third message transmitted to the first aerial relay, the third messages transmitted to the second aerial relay and the third aerial relay may not include the speed information of the counterpart node. In FIG. 10B, only the first aerial relay, the counterpart node, and the base station may be illustrated for simplification of the drawing.

In step S1054, the first aerial relay may receive the third message including the speed information of the counterpart node and the information indicating that the first aerial relay is determined as a relay node. More specifically, the receiver 12 of the first aerial relay may receive the third message, convert the received message into a baseband signal, and provide the baseband signal to the position change device 43.

The position change device 43 may identify the speed information of the counterpart node based on the received third message and may identify that the first aerial relay has been determined as a relay node. The position change device 43 may provide a speed request (or command) for the first aerial relay to the position acquisition device 414 in order to acquire the speed of the first aerial relay.

When the position acquisition device 414 receives the speed request for the first aerial relay, the position acquisition device 414 may acquire speed information of the first aerial relay based on information received from the inertial measurement device included in the sensor 20 or based on reception of GNSS signals. The position acquisition device 414 may then provide the acquired speed information of the first aerial relay to the position change device 43.

In step S1054, the position change device 43 may compensate for Doppler shift of a signal received from the counterpart node by using the speed information of the first aerial relay provided from the counterpart node and the sensor information acquisition device 414. In addition, the position change device 43 may configure the first aerial relay to operate as a relay node. In the exemplary embodiment of FIG. 10B, the first aerial relay operating as the relay node may control the motor 30 so that the first aerial relay moves in accordance with the speed of the counterpart node.

The position change device 43 may generate an operation performance report message for reporting completion of configuring the first aerial relay to operate as the relay node. The position change device 43 may provide the operation performance report message to the transmitter 11.

In step S1056, the transmitter 11 may convert the operation performance report message into an RF band and may transmit the operation performance report message to the base station through antennas. In this case, a link from the first aerial relay to the base station may be a relay link or may be an uplink of a mobile communication system. When an uplink of a mobile communication system is used, uplink resources preconfigured for the first aerial relay by the base station may be used.

In step S1058, the base station may receive the operation performance report message from the first aerial relay. Accordingly, the base station may identify that the first aerial relay operates as a relay node for the counterpart node.

In step S1058, the base station may generate a response message responding to reception of the operation performance report message and may transmit the response message to the first aerial relay. The first aerial relay may receive the response message.

According to the exemplary embodiments of FIG. 10A and FIG. 10B described above, unlike the case in which the aerial relay makes a determination, the counterpart node may determine a movement operation of a specific aerial relay. Therefore, the counterpart node may provide a movement command to an aerial relay that is close to the counterpart node by integrally utilizing position information of multiple aerial relays. Through this, there is an advantage in that collisions between aerial relays may be controlled.

The second exemplary embodiment of the method in which the network determines position tracking of the counterpart node and a relay node for the counterpart node described above may correspond to a case in which the counterpart node has a MIMO antenna and/or a plurality of antennas.

Meanwhile, although the AoA-based position estimation method has been described in the exemplary embodiments of FIG. 10A and FIG. 10B, the same or similar form may also be applied to a case in which position information is acquired based on GNSS information or based on TDoA.

For example, when the counterpart node acquires GNSS information of each of the aerial relays and also acquires GNSS information of the counterpart node itself, the counterpart node may determine an appropriate aerial relay to operate as a relay node based on the position of the counterpart node acquired from its GNSS information and based on the positions of the respective aerial relays acquired from their GNSS information.

In addition, when direction information of each of the aerial relays is further received from the aerial relays based on an instruction of the network (e.g., the base station), the counterpart node may more effectively determine an aerial relay to operate as a relay node by considering the direction information of the counterpart node together. The direction information of each of the aerial relays and the direction information of the counterpart node may be acquired by using the inertial measurement device as described above or may be acquired based on GNSS information at two or more different times.

In addition, to compensate for GNSS uncertainty caused by jitter, a specific reference signal may be used. For example, based on an instruction of the network, each of the aerial relays may transmit a reference signal such as a pilot signal to the counterpart node. The counterpart node may estimate the position of each of the aerial relays by using the AoAs of the pilot signals received from each of the aerial relays. By further considering and correcting the estimated positions of the aerial relays, the counterpart node may determine a more appropriate aerial relay when selecting a relay node.

When the counterpart node acquires TDoA-based position information of the aerial relays, the counterpart node may operate as follows. Each of the aerial relays may transmit a signal for measuring TDoA (e.g. a reference signal such as a pilot signal) to adjacent aerial relays. Each aerial relay that receives the pilot signal for measuring TDoA may transmit information on an arrival time at which the pilot signal is received to the base station. Accordingly, the base station may estimate a position of the aerial relay that transmitted the reference signal based on the received arrival time information. After collecting position information of the respective aerial relays in this manner, the base station may transmit the collected position information to the counterpart node.

The aerial relay may additionally receive speed information of the counterpart node in order to compensate for Doppler shift occurring when the aerial relay receives a transmission command for the pilot signal and a movement command from the base station. The base station may instruct the aerial relay to utilize both the speed information of the counterpart node and the speed information of the aerial relay. In this case, the speed information of the counterpart node may be received by the aerial relay either from the counterpart node or from the base station. The speed of the aerial relay may be determined based on the method described above. When the aerial relay is not able to autonomously calculate (or acquire) its speed, speed information of the aerial relay may be received from the network.

When the counterpart node receives the pilot signal or position and direction information of the aerial relay, the base station may instruct the counterpart node to compensate for Doppler shift. When the base station provides such an instruction, information utilized for Doppler shift compensation may include the speed of the aerial relay and the speed of the counterpart node. Accordingly, the base station may instruct the counterpart node and/or the aerial relay to further provide speed information for Doppler shift compensation.

When the counterpart node and/or the aerial relay is not able to acquire speed information, the network (e.g. the base station) may provide the speed information to the counterpart node and/or the aerial relay.

In addition, the first exemplary embodiment of the method in which the network determines position tracking of the counterpart node and determines an aerial relay to operate as a relay node may be an exemplary embodiment for a case where the counterpart node has a single antenna. However, the present disclosure may also assume a case in which the counterpart node has a MIMO antenna.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of an aerial relay, the method comprising:
estimating, at first time intervals for a predetermined number of times, a position of the aerial relay based on a pilot signal received from a base station;
measuring a quality of the received pilot signal whenever the position of the aerial relay is estimated;
transmitting, at the first time intervals for the predetermined number of times, a report message including the estimated position of the aerial relay and the quality of the received pilot signal to the base station;
moving to a first position based on receiving, from the base station, a first message including instruction information for instructing the aerial relay to operate as a relay node and information on the first position in response to the report message; and
transmitting a movement report message to the base station based on the aerial relay being moved to the first position,
wherein the aerial relay moves by a predetermined distance at the first time intervals.

2. The method of claim 1, wherein the predetermined number is a value preset by the base station through a first link established between the base station and the aerial relay, and the first link is different from a second link through which the aerial relay relays a signal transmitted from the base station to a terminal while the aerial relay operates as the relay node.

3. The method of claim 1, wherein a resource in which the report message is transmitted is preconfigured through a first link established between the base station and the aerial relay, and the first link is different from a second link through which the aerial relay relays a signal transmitted from the base station to a terminal while the aerial relay operates as the relay node.

4. The method of claim 1, wherein the position of the aerial relay is estimated using an angle of arrival (AoA) of the pilot signal received from the base station.

5. The method of claim 1, further comprising: operating as the relay node based on receiving a response signal for the movement report message from the base station.

6. The method of claim 1, further comprising:
acquiring position information of the aerial relay based on satellite signals received from a plurality of satellites at the first time intervals for the predetermined number of times; and
correcting the position information of the aerial relay acquired based on the satellite signals using the estimated position of the aerial relay.

7. The method of claim 1, further comprising: acquiring movement direction information of the aerial relay, wherein the report message further includes the movement direction information.

8. A method of a base station, the method comprising:
transmitting, at first time intervals for a predetermined number of times, a pilot signal to each of aerial relays located within coverage of the base station;
receiving, at the first time intervals, a report message from each of the aerial relays;
determining a position of a first aerial relay based on the report messages; and
transmitting, to the first aerial relay, a first message including the position of the first aerial relay,
wherein each of the report messages includes a position of each of the aerial relays and a quality of the pilot signal measured by each of the aerial relays.

9. The method of claim 8, wherein the predetermined number is a value preset by the base station through a first link established between the base station and the aerial relays, and the first link is different from a second link used for one aerial relay among the aerial relays to relay a signal transmitted from the base station to a terminal while the one aerial relay operates as a relay node.

10. The method of claim 8, wherein a resource in which the report message is transmitted is preconfigured through a first link established between the base station and the aerial relays, and the first link is different from a second link used for one aerial relay among the aerial relays to relay a signal transmitted from the base station to a terminal while the one aerial relay operates as a relay node.

11. The method of claim 8, wherein the pilot signal is transmitted through respective beams that are being swept, and each of the report messages is received through a beam corresponding to a direction of a beam through which each of the aerial relays receives the pilot signal among the swept beams.

12. The method of claim 8, further comprising:
receiving, from the first aerial relay, a movement report message including movement completion information of the first aerial relay; and
transmitting a response message responding to the movement report message to the first aerial relay.

13. The method of claim 12, further comprising: transmitting, to a positioning server of a network, position information of the first aerial relay based on reception of the movement report message of the first aerial relay.

14. The method of claim 8, wherein each of the report messages further includes movement direction information of each of the aerial relays, and the determining of the position of the first aerial relay further considers the movement direction of the first aerial relay based on the movement direction information.

15. A method of an aerial relay, the method comprising:
estimating, at first time intervals for a predetermined number of times, a position of the aerial relay based on a pilot signal received from a base station;
measuring a quality of the received pilot signal whenever the position of the aerial relay is estimated;
determining a position at which the aerial relay is to operate as a relay node based on the qualities of the pilot signal measured for the predetermined number of times;
transmitting a first message including the determined position to the base station;
moving to the determined position in response to receiving a response message from the base station; and
operating as the relay node,
wherein the aerial relay moves by a predetermined distance at the first time intervals.

16. The method of claim 15, wherein the predetermined number is a value preset by the base station through a first link established between the base station and the aerial relay, and the first link is different from a second link through which the aerial relay relays a signal transmitted from the base station to a terminal while the aerial relay operates as the relay node.

17. The method of claim 15, wherein the position of the aerial relay is estimated using an angle of arrival (AoA) of the pilot signal received from the base station.

18. The method of claim 15, wherein the operating as the relay node further comprises:
transmitting a second message including final position information of the aerial relay to the base station based on movement of the aerial relay; and
operating as the relay node based on receiving, from the base station, a response signal responding to the second message.

19. The method of claim 15, further comprising:
acquiring position information of the aerial relay based on satellite signals received from a plurality of satellites at the first time intervals for the predetermined number of times; and
correcting the position information of the aerial relay acquired based on the satellite signals using the estimated position of the aerial relay.

20. The method of claim 19, further comprising: acquiring movement direction information of the aerial relay, wherein the report message further includes the movement direction information.
